(19) United States
(12) Patent Application Publication
(10) Pub. No.: US 2012/0274661 A1
(43) Pub. Date: Nov. 1, 2012

(54) INTERACTION METHOD, MOBILE DEVICE, AND INTERACTIVE SYSTEM

(75) Inventors: Zhou YE, Foster City, CA (US); Pei-Chuan LIU, Taipei City (TW); Ying-Ko LU, Taoyuan County (TW); Yun-Fei WEI, Taipei City (TW); San-Yuan HUANG, Taipei City (TW)

(73) Assignee: BlueSpace Corporation, Apia (WS)

(21) Appl. No.: 13/455,469

(22) Filed: Apr. 25, 2012

Related U.S. Application Data
(60) Provisional application No. 61/478,945, filed on Apr. 26, 2011.

(51) Int. Cl. G09G 5/00

(52) U.S. Cl. 345/629

(57) ABSTRACT

A mobile device implements a method for interacting with an electronic device having a display function. The mobile device is operable to display at least one image including a primary image portion and a first secondary image portion. In the method, the mobile device is configured to transmit the primary image portion to the electronic device, to transform the first secondary image portion into a second secondary image portion that conforms with a specified presentation, to display the second secondary image portion, to generate a new primary image portion in response to a control signal, and to transmit the new primary image portion to the electronic device for display by the electronic device.

### CROSS-REFERENCE TO RELATED APPLICATION

This application claims priority of U.S. Provisional Application No. 61/478,945, filed on Apr. 26, 2011.

### BACKGROUND OF THE INVENTION

1. Field of the Invention

The invention relates to a mobile device, more particularly to a mobile device that is capable of interacting with an electronic device having a display function.

2. Description of the Related Art

Smart phones have evolved rapidly as a result of increasing demands and competitions among manufacturers, providing a wide variety of features such as internet browsing, video games and video conferencing. However, the size of the screen of the smart phone is limited for the sake of portability, and thus may not meet the needs of users that play video games using the smart phone.

Therefore, a conventional interactive system 900 has been provided, as shown in FIG. 1. A smart phone 910 is operable to, via the interactive system 900, transmit a gaming screen 911 to a display device 920 with a larger size in real time, thereby allowing users to play the video game with the display device 920.

Nonetheless, the interactive system 900 does not display a virtual button set 912 that is associated with video game control satisfactorily on the screen of the smart phone 910 while the display device 920 displays the gaming screen 911. As a result, users must pay attention to the screen of the smart phone 910 and the display device 920 concurrently when playing the video game, which results in some difficulty. Additionally, the rotate function of the smart phone 910 is generally not available to be configured according to different software or game or office applications, and may cause inconvenience to users.

### SUMMARY OF THE INVENTION

Therefore, one object of the present invention is to provide a method for a mobile device to interact with an electronic device having a display function.

According to one aspect, a method of the present invention is to be implemented by the mobile device for interacting with the electronic device. The mobile device is operable to display at least one image that is generated by a processor of the mobile device that executes a program. The image includes a primary image portion and a first secondary image portion that is superimposed on the primary image portion. The method comprises the following steps of:

configuring the mobile device to transmit the primary image portion to the electronic device for display by the electronic device;

configuring the mobile device that executes the program to transform the first secondary image portion into a second secondary image portion that conforms with a specified presentation;

configuring the mobile device to display the second secondary image portion;

configuring the mobile device that executes the program to generate a new primary image portion in response to a control signal generated as a result of user operation; and

configuring the mobile device to transmit the new primary image portion to the electronic device for display by the electronic device.

According to another aspect, a method of the present invention is to be implemented by a mobile device for interacting with an electronic device having a display function. The mobile device is operable to display at least one image generated by a processor of the mobile device that executes a program. The method comprises the following steps of:

configuring the mobile device to transmit the image to the electronic device for display by the electronic device;

configuring the mobile device to generate a new image in response to a control signal from a peripheral device that is operatively coupled to the mobile device; and

configuring the mobile device to transmit the new image to the electronic device for display by the electronic device.

Yet another object of the invention is to provide a mobile device that is operable to implement the aforementioned methods.

Still another object of the invention is to provide an interactive system that comprises an electronic device having a display function and a mobile device that is operable to implement the aforementioned methods, such that the mobile device is capable of interacting with the electronic device in real time.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram of a conventional interactive system;

FIG. 2 is a schematic block diagram of a first preferred embodiment of an interactive system according to the invention;

FIG. 3 is a schematic diagram of an image generated by a mobile device of the first preferred embodiment that executes a program;

FIG. 4 is a flow chart of a method for a mobile device to interact with an electronic device having a display function, according to the first preferred embodiment;

FIG. 5 is a schematic diagram illustrating interaction between the mobile device and the electronic device according to the first preferred embodiment, where the electronic device is configured to display only a primary image portion;

FIG. 6 illustrates different examples of virtual operation buttons;

FIG. 7 is a flow chart illustrating setup of the interactive system before performing the method of FIG. 4, where a new game is executed and a first secondary image portion and a second secondary image portion are built-in objects;

FIG. 8 is a schematic diagram illustrating interaction between the mobile device and the electronic device according to the first preferred embodiment, where the electronic device is configured to display the primary image portion and the first secondary image portion;

FIG. 9 is a flow chart illustrating how a control unit of the mobile device generates a new primary image portion in response to a control signal according to the first preferred embodiment, where the new game is executed and the first secondary image portion and the second secondary image portion include built-in objects;

FIG. 10 is a schematic diagram illustrating a multilayer architecture of the interactive system, according to the first preferred embodiment;

FIG. 11 is a schematic diagram illustrating appearances of one virtual operation button of the first secondary image portion and a corresponding part of the second secondary image portion being changed simultaneously;

FIG. 12 is a flow chart illustrating setup of the interactive system before performing the method of FIG. 4, where a new game is executed and a first secondary image portion and a second secondary image portion are new button images;

FIG. 13 is a flow chart illustrating how the control unit of the mobile device generates the new primary image portion in response to the control signal according to the first preferred embodiment, where the new game is executed and the first secondary image portion and the second secondary image portion are new button images;

FIG. 14 is a flow chart illustrating setup of the interactive system before performing the method of FIG. 4, where an existing game is executed;

FIG. 15 is a flow chart illustrating how the control unit of the mobile device generates the new primary image portion in response to the control signal according to the first preferred embodiment, where the existing game is executed;

FIG. 16 is a schematic diagram illustrating that an area of a specific second button image on the second secondary image portion is mapped onto the center of a corresponding area of a linked one of the first objects on the first secondary image portion;

FIG. 17 is a schematic block diagram of a second preferred embodiment of an interactive system according to the invention;

FIG. 18 is a schematic diagram illustrating interaction between the mobile device and the electronic device according to the second preferred embodiment, where a peripheral device is operatively coupled to the mobile device;

FIG. 19 is a flow chart of a method for the mobile device to interact with the electronic device, according to the second preferred embodiment;

FIG. 20 is a flow chart illustrating setup of the interactive system before performing the method of FIG. 19, where a new game is executed;

FIG. 21 is a flow chart illustrating how the control unit of the mobile device generates the new primary image portion in response to the press signal from the peripheral device according to the second preferred embodiment, where the new game is executed;

FIG. 22 is a schematic diagram illustrating a multilayer architecture of the interactive system, according to the second preferred embodiment;

FIG. 23 is a flow chart illustrating setup of the interactive system before performing the method of FIG. 19, where an existing game is executed;

FIG. 24 is a flow chart illustrating how the control unit of the mobile device generates the new primary image portion in response to the press signal from the peripheral device according to the second preferred embodiment, where the existing game is executed;

FIG. 25 is a schematic block diagram of a third preferred embodiment of an interactive system according to the invention;

FIG. 26 is a schematic diagram illustrating interaction between the mobile device and the electronic device according to the third preferred embodiment, where a peripheral device is operatively coupled to the mobile device and provides a press key unit;

FIG. 27 is a flow chart of a method for the mobile device to interact with the electronic device, according to the third preferred embodiment;

FIG. 28 is a flow chart illustrating setup of the interactive system before performing the method of FIG. 27, where a new game is executed;

FIG. 29 is a flow chart illustrating how the control unit of the mobile device generates the new primary image portion in response to a touch control signal from a signal generator or to a press signal from the peripheral device according to the third preferred embodiment, where the new game is executed;

FIG. 30 is a schematic view illustrating a multilayer architecture of the interactive system, according to the third preferred embodiment;

FIG. 31 is a flow chart illustrating setup of the interactive system before performing the method of FIG. 27, where the existing game is executed;

FIG. 32 is a flow chart illustrating how the control unit of the mobile device generates the new primary image portion in response to the touch control signal from the signal generator or to the press signal from the peripheral device according to the third preferred embodiment, where the existing game is executed;

FIG. 33 is a schematic block diagram of a fourth preferred embodiment of an interactive system according to the invention;

FIG. 34 is a schematic diagram illustrating interaction between the mobile device and the electronic device according to the fourth preferred embodiment, where a peripheral device includes a joystick or gamepad that communicates wirelessly with the mobile device;

FIG. 35 is a schematic block diagram of a fifth preferred embodiment of an interactive system according to the invention;

FIG. 36 is a flow chart of a method for the mobile device to interact with the electronic device, according to the fifth preferred embodiment;

FIG. 37 is a schematic diagram illustrating a primary image portion and a first secondary image portion that are displayed by the electronic device, according to the fifth preferred embodiment;

FIG. 38 is a schematic diagram illustrating a second secondary image portion that is displayed by the mobile device, according to the fifth preferred embodiment;

FIG. 39 is a flow chart illustrating how the control unit of the mobile device generates the new primary image portion in response to a motion signal according to the fifth preferred embodiment, where the mobile device operates in an air mouse mode;

FIG. 40 illustrates the movement of the mobile device in both a yaw axis and a pitch axis;

FIGS. 41 and 42 are schematic diagrams illustrating two specific configurations respectively presenting a second secondary image portion displayed by the mobile device;

FIG. 43 is a schematic view illustrating the mobile device in a landscape control mode; and

FIG. 44 is a flow chart illustrating how the control unit of the mobile device generates the new primary image portion in response to the motion signal according to the fifth preferred embodiment, where the mobile device is in an axis transformation mode.

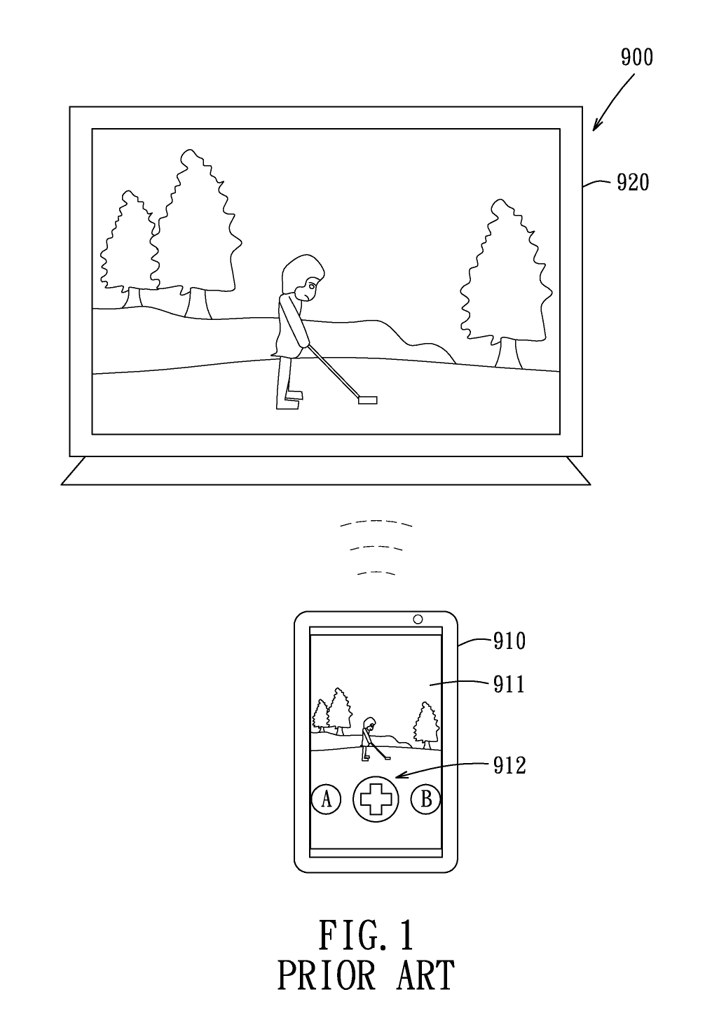

### DETAILED DESCRIPTION OF THE PREFERRED EMBODIMENTS

Before the present invention is described in greater detail, it should be noted that like elements are denoted by the same reference numerals throughout the disclosure.

### First Embodiment

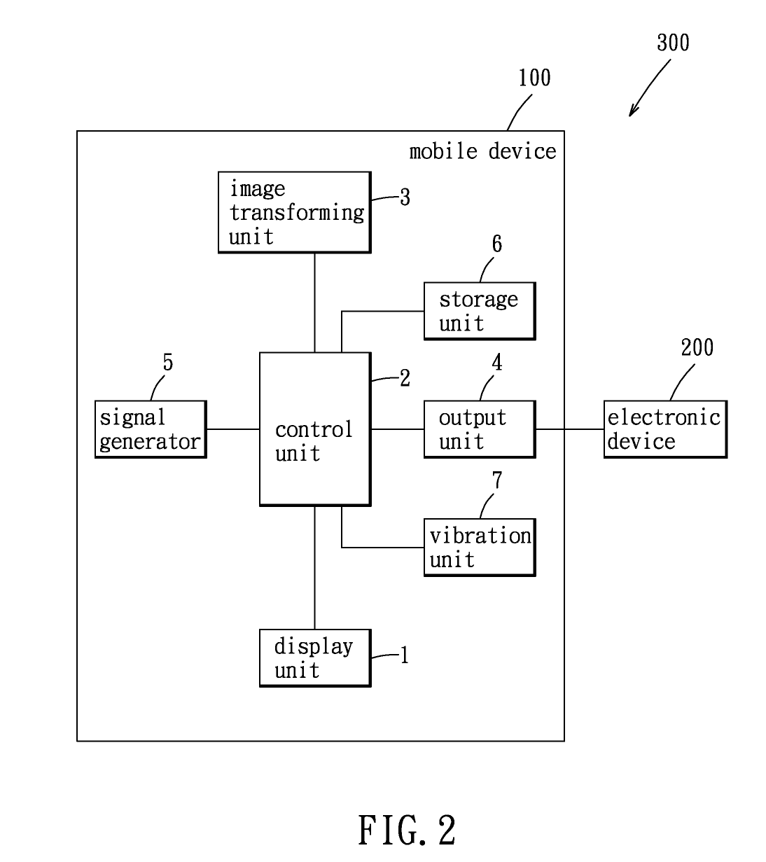

FIG. 2 illustrates the first preferred embodiment of an interactive system 300 according to the present invention. The interactive system 300 includes a mobile device 100 and an electronic device 200 that has a display function. In this embodiment, the mobile device 100 is, but not limited to, a smart phone, PDA, or tablet computer; and the electronic device 200 is, but not limited to, a liquid crystal display (LCD), a tablet computer or an internet television in other embodiments.

The mobile device 100 includes a display unit 1, a control unit 2 that is coupled to the display unit 1, an image transforming unit 3 that is coupled to the control unit 2, an output unit 4, a signal generator 5 and a storage unit 6. In this embodiment, the control unit 2 may be a processor or CPU or GPU of the mobile device 100, and is operable to control operations of the various components of the mobile device 100.

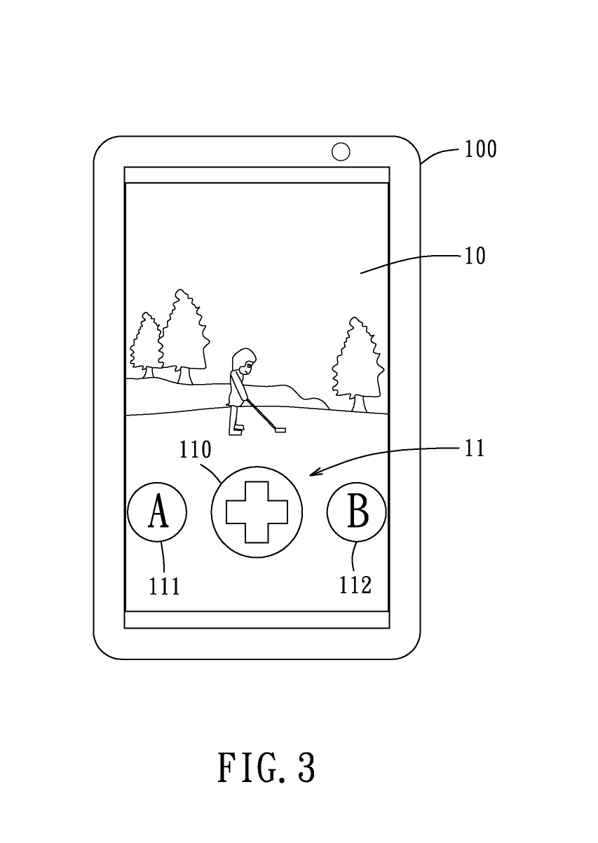

The display unit 1 may be a touch screen of the mobile device 100, for displaying an image as shown in FIG. 3. The image is generated by the control unit 2 of the mobile device 100 that executes a program (e.g., a video game application, a widget or an office application), and the image includes a primary image portion 10 and a first secondary image portion 11 that is superimposed on the primary image portion 10. In this embodiment, the first secondary image portion 11 is a virtual button set presented in a user interface that includes three button images, namely a first directional pad (D-pad) 110, a first operation button (A) 111 and a first operation button (B) 112.

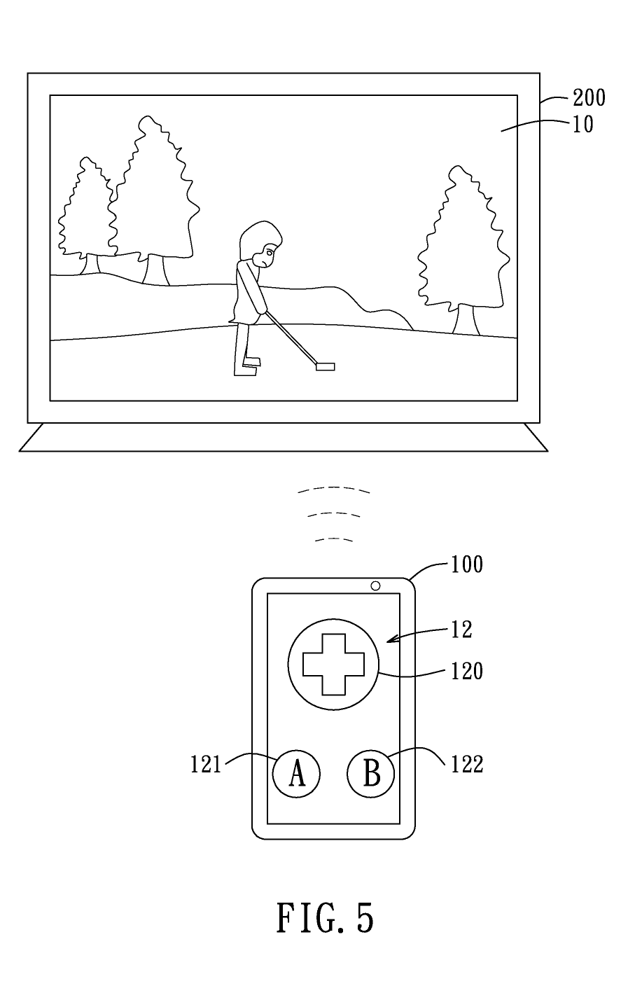

The image transforming unit 3 is operable to transform the first secondary image portion 11 into a second secondary image portion 12 that conforms with a specified presentation, that serves as a user interface, and that is displayed by the display unit 1 of the mobile device 100 (as shown in FIG. 5). A detailed operation of the image transforming unit 3 will be described in the succeeding paragraphs.

The output unit 4 is operable to, upon being instructed by the control unit 2, transmit the primary image portion 10 to the electronic device 200 for display by the electronic device 200 (as shown in FIG. 5). The image transmission can be wired or wireless, and the primary image portion 10 can be processed by known image codec transformation techniques for more efficient transmission. The signal generator 5 is a touch sensing electronic circuit disposed at the display unit 1, and is operable to generate a control signal as a result of user operation (i.e., a result of a touch event).

The storage unit 6 is provided for storing a plurality of setup values that are set by the user and associated with the mobile device 100. Besides, the control unit 2 can be a processor to handle all or part of the circuitry operations.

Referring to FIGS. 2 to 5, a method implemented by the mobile device 100 for interacting with the electronic device 200 will now be described in detail. Specifically, since this embodiment is exemplified using a user playing a video game, the primary image portion 10 is a gaming screen, and the first secondary image portion 11 is a virtual button set presented in a user interface that is associated with the video game. When the video game is executed and the image associated with the video game is generated, and when a request for interacting the mobile device 100 with the electronic device 200 is activated from the user, the mobile device 100 is operable to perform the following steps.

In step S11, the control unit 2 of the mobile device 100 is operable to configure the output unit 4 to transmit the primary image portion 10 to the electronic device 200 for display by the electronic device 200, upon receiving the request from the user.

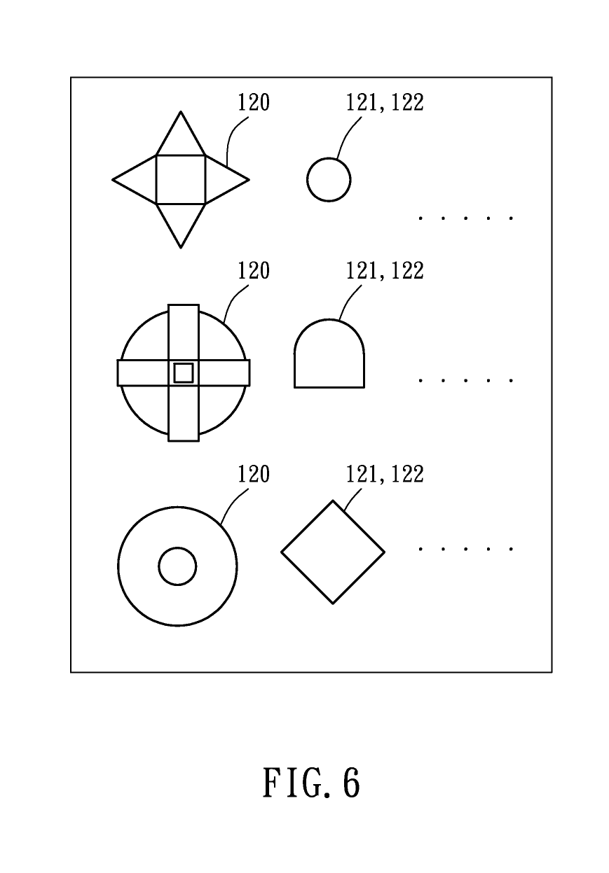

In step S12, the control unit 2 of the mobile device 100 is operable to transform the first secondary image portion 11 (see FIG. 3) into a second secondary image portion 12 that conforms with a specified presentation (see FIG. 5). In this embodiment, the transformed second secondary image portion 12 includes a second D-pad 120, a second operation button (A) 121 and a second operation button (B) 122, that are associated respectively with the first D-pad 110, the first operation button (A) 111 and the first operation button (B) 112 of the first secondary image portion 11. Furthermore, for the sake of making it easier for the user to play the video game, each of the buttons 120, 121, 122 in the second secondary image portion 12 has a larger size than the associated one of the buttons 110, 111, 112 in the first secondary image portion 11. However, the configuration of the second secondary image portion 12 (e.g., size, location and shape) can be specified or customized by the user via the user interface of the mobile device 100 (examples are shown in FIG. 6). The specified presentation can be stored in the storage unit 6, and can be saved as a default configuration for the next time the video game restarts.

In step S13, the control unit 2 of the mobile device 100 is operable to configure the display unit 1 to display the second secondary image portion 12. That is, the primary image portion 10 and the second secondary image portion 12 are displayed by the electronic device 200 and the mobile device 100, respectively.

In step S14, the control unit 2 of the mobile device 100 is operable to generate a new primary image portion 10 in response to a control signal generated by the signal generator 5 as a result of user operation. In this embodiment, the user operation involves the user touching the second secondary image portion 12 on the display unit 1 (e.g., touching the second operation button (A) 121), prompting the signal generator 5 to generate a control signal indicating a touch event the associated operation button. The control unit 2 is then operable to generate a new primary image portion 10 in response (e.g., swing of a golf club).

Then, in step S15, the control unit 2 of the mobile device 100 is operable to configure the output unit 4 to transmit the new primary image portion 10 to the electronic device 200 for display by the electronic device 200 in real time. This serves as a response to the user operation.

In addition, in order to make the user aware of a successful touch event on the operation buttons of the second secondary image portion 12, the mobile device 100 may further include a vibration unit 7 (see FIG. 2) that is coupled to the control unit 2, and that is operable to vibrate at a specified frequency in response to a detected touch event on one of the operation buttons of the second secondary image portion 12. Thus, the user can concentrate on video content displayed at the electronic device 200 without looking at the display unit 1 of the mobile device 100. It is worth noting that, while each operation button 120,121,122 of the second secondary image portion 12 is assigned to a specific vibration frequency in this embodiment, the vibration frequency associated with each of the operation buttons of the second secondary image portion 12 can also be configured by the user through the user interface.

Setup of the interactive system 300 before performing step S11 and the flow of step S14, in which the control unit 2 of the mobile device 100 generates the new primary image portion 10, will now be described in detail in the following, with respect to a new game (i.e., a newly developed application that is compatible with the interactive system 300, and parameters thereof are adjustable) and an existing game (i.e., an application that has been developed commercially and parameters thereof are not adjustable).

The following paragraphs are directed to the case in which a new game is executed, and each of the first secondary image portion 11 and the second secondary image portion 12 includes objects built in the Android operating system (OS).

Referring to FIGS. 3 to 5, each of the first D-pad 110, the first operation button (A) 111 and the first operation button (B) 112 is defined in the new game as a distinct first object, while each of the second D-pad 120, the second operation button (A) 121 and the second operation button (B) 122 is defined using the user interface as a distinct second object that is associated with a corresponding one of the first objects. Particularly, each set of a specific first object and a corresponding second object is registered with a particular event of the user operation. As a result, when one of the second objects (e.g., the second D-pad 120) is touched by the user, the touch event in turn triggers the corresponding first object (first D-pad 110) concurrently, and the new game is operable to make a corresponding response thereto.

It should be noted that, while this invention is exemplified using Android operating system (OS) as a development platform, other operating systems may be employed in other embodiments of this invention.

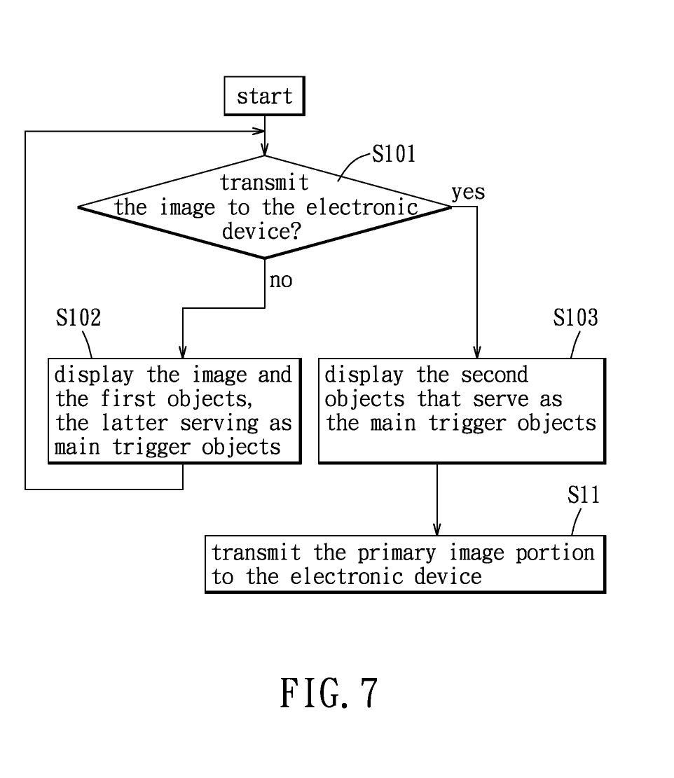

Referring to FIGS. 2, 4 and 7, when the new game is executed and the image associated with the new game is generated, the control unit 2 is operable to determine, by for example detecting the request for interacting the mobile device 100 with the electronic device 200, whether or not to transmit the game image to the electronic device 200 in step S101. The request activated by the user at the mobile device for interaction with the electronic device 200 is sent by the user via the user interface of the mobile device 100 in this embodiment, but may be sent using other means in other embodiments. The flow goes to step S103 when the determination made in step S101 is affirmative, and goes to step S102 when otherwise.

In step S102, the control unit 2 is operable to configure the display unit 1 to display the image and the first objects, the latter serving as main trigger objects. For example, the user may only desire to use the mobile device rather than the electronic device for playing the video game.

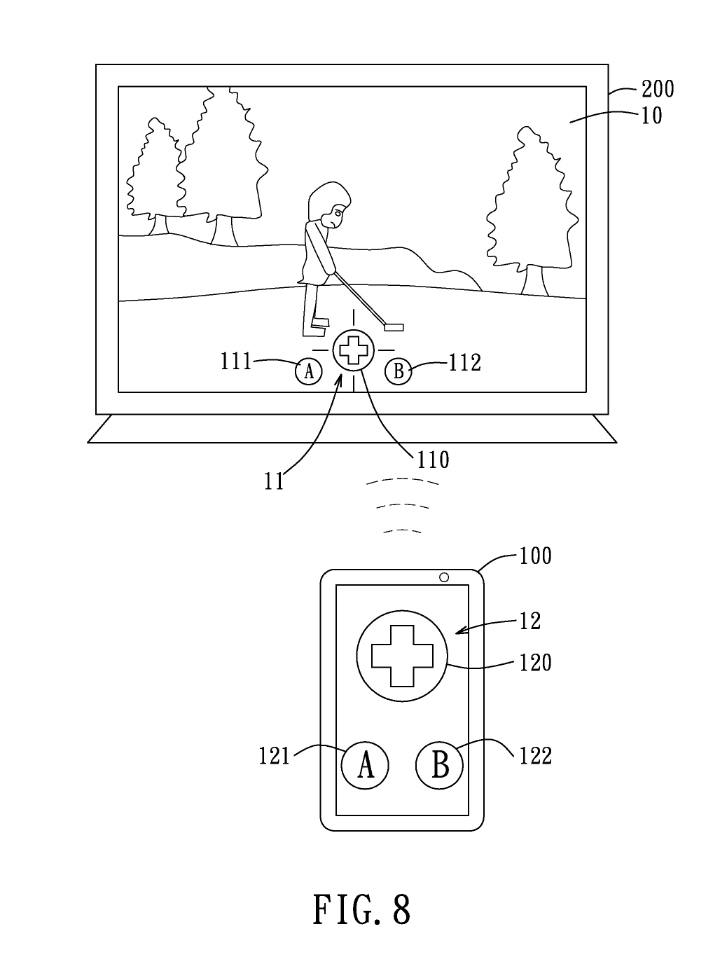

In step S103, the control unit 2 is operable to configure the display unit 1 to display the second objects that serve as the main trigger objects, and the flow goes to step S11, in which the control unit 2 is operable to transmit the primary image portion 10 and optionally the first secondary image portion 11 that is superimposed on the primary image portion 10 to the electronic device 200 for display by the electronic device 200 (as shown in FIG. 8).

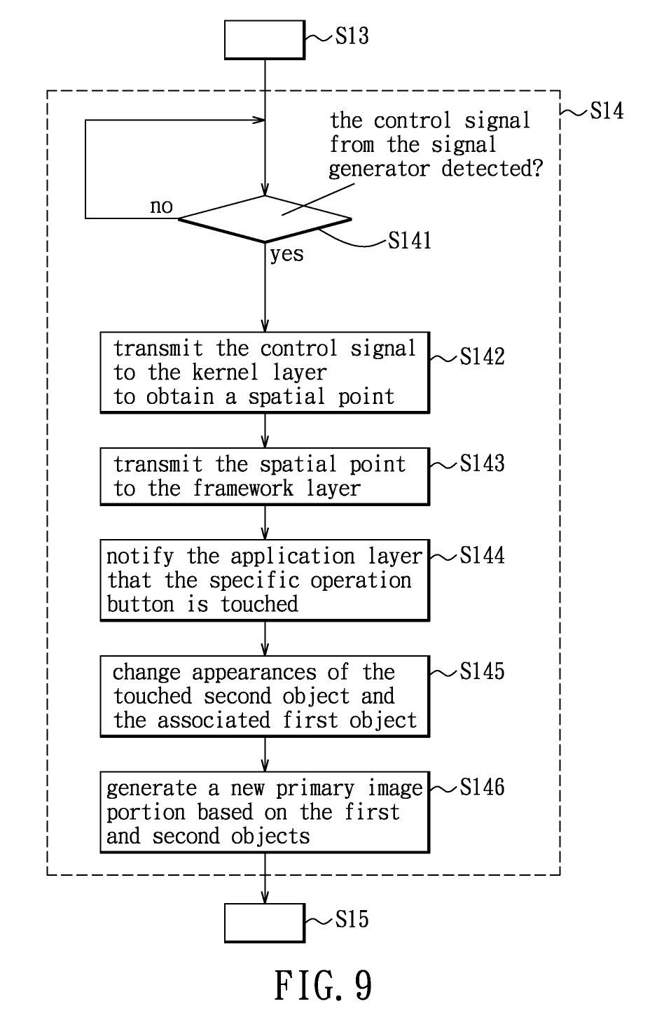

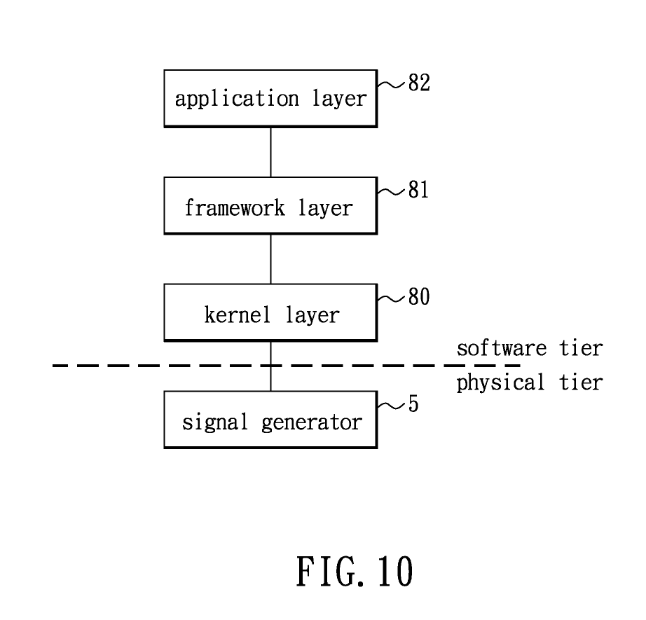

FIG. 9 illustrates the sub-steps of step S14, in which the control unit 2 of the mobile device 100 generates a new primary image portion 10 in response to a control signal generated by the signal generator 5. The flow of step S14 will be described in detail with reference to FIG. 10, which illustrates a multilayer architecture of the interactive system 300. In this embodiment, the multilayer architecture includes a software tier having a kernel layer 80, a framework layer 81 and an application layer 82, and a physical tier that contains the physical electronic circuit of the signal generator 5.

In step S141, the control unit 2 is operable to detect the control signal from the signal generator 5 in the physical tier. The flow goes to step S142 when the control signal is detected, and goes back to step S141 when otherwise. The control signal is a result of a touch event in this embodiment, and the signal generator 5 can generate the control signal from events of other components in the physical tier, such as at least one of a motion detector and a peripheral device.

In step S142, the control unit 2 is operable to transmit the control signal to the kernel layer 80. The kernel layer 80 is configured to process the control signal and to obtain a spatial point that is associated with a location of the display unit 1 touched by the user.

In step S143, the spatial point is then transmitted to the framework layer 81.

Then, in step S144, the spatial point serves as a reference in a callback operation, in which the control unit 2 transmits the spatial point from the framework layer 81 to the application layer 82. For example, the framework layer 81 may include a program library that is operable to link the kernel layer 80 with the application layer 82 in the android operating system, and to associate the spatial point to a specific operation button on the user interface, which is further associated with a specific button parameter that is defined by the application in the application layer 82. Thus, the application layer 82 is notified that the specific operation button (e.g., the second D-pad 120, the second operation button (A) 121 or the second operation button (B) 122) is touched.

The flow then goes to step S145, in which the control unit 2 is operable to change appearances of the second object that is touched and the associated first object (e.g., change in color and/or size), through the framework layer 81. The first and second objects thus altered are then displayed respectively by the display unit 1 and the electronic device 200 for informing the user of the detected touch event on the specific operation button.

In step S146, the control unit 2 is operable to generate a new primary image portion 10 based on the first and second objects through the application layer 82. It is noted that the kernel layer 80 is responsible for the steps 141 through 143, the framework layer 81 for the steps 144 and 145, and the application layer 82 for the step 146.

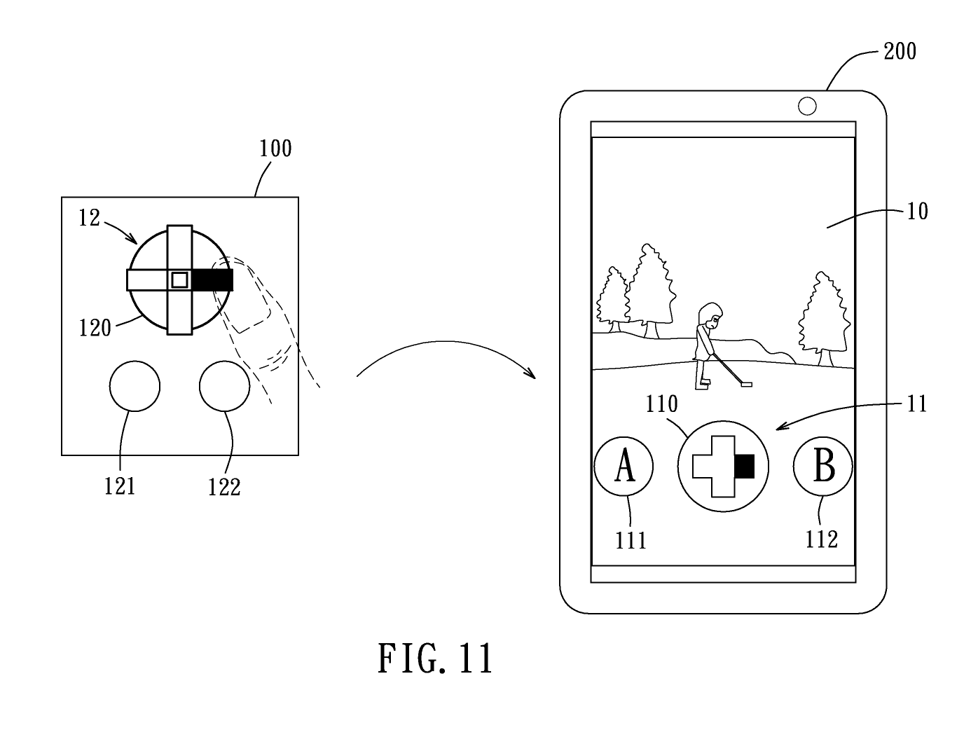

FIG. 11 illustrates an example resulting from the process of FIG. 9. A second object of the user interface (shown in the left sidle of the Figure) is associated with a first object displayed by the electronic device 200 (shown in the right side of the Figure) such that appearances thereof can be changed concurrently, and the user can be instantly informed that the specific operation button is touched by simply looking at the electronic device 200. It is worth noting that appearances (i.e., color, shape, etc.) of the first object and the second object may or may not be identical.

In this embodiment, the electronic device 200 can be configured to only display the primary image portion 10, as shown in FIG. 5. In such case, in step S145, only appearance of the touched second object is changed through the framework layer 81. The control unit 2 then generates the new primary image portion 10 based on the second object in step S146 (see FIG. 9).

The following paragraphs are directed to the case in which a new game is executed, and each of the first secondary image portion 11 and the second secondary image portion 12 includes objects having new button layouts designed by the user or application developer, as shown in FIGS. 3 and 5. The first D-pad 110, the first operation button (A) 111 and the first operation button (B) 112 are three distinct first button images, while the second D-pad 120, the second operation button (A) 121 and the second operation button (B) 122 are three distinct second button images.

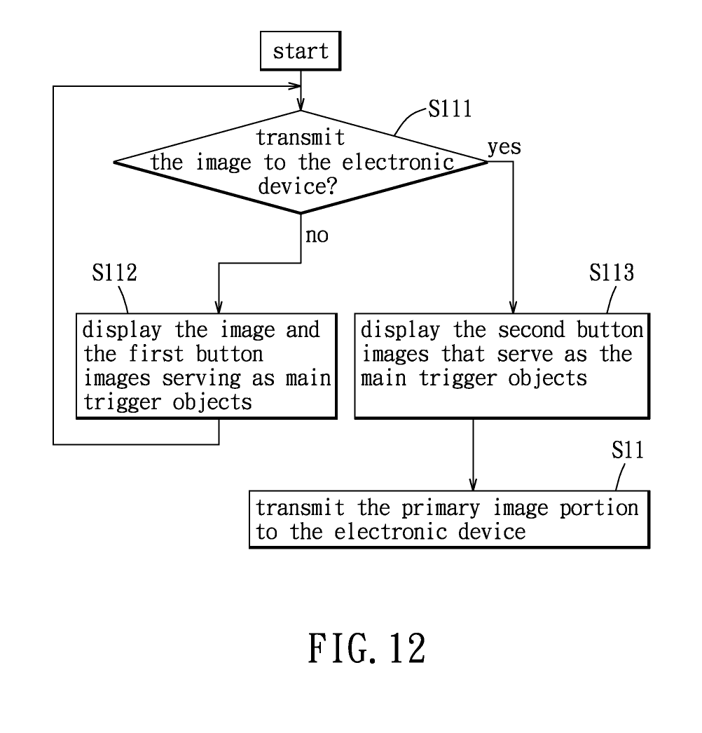

Referring to FIGS. 2, 4 and 12, when the new game is executed and the image associated with the new game is generated, the control unit 2 is operable to determine whether or not to transmit the game image to the electronic device 200 in step S111. The flow goes to step S113 when the determination made in step S111 is affirmative, and goes to step S112 when otherwise.

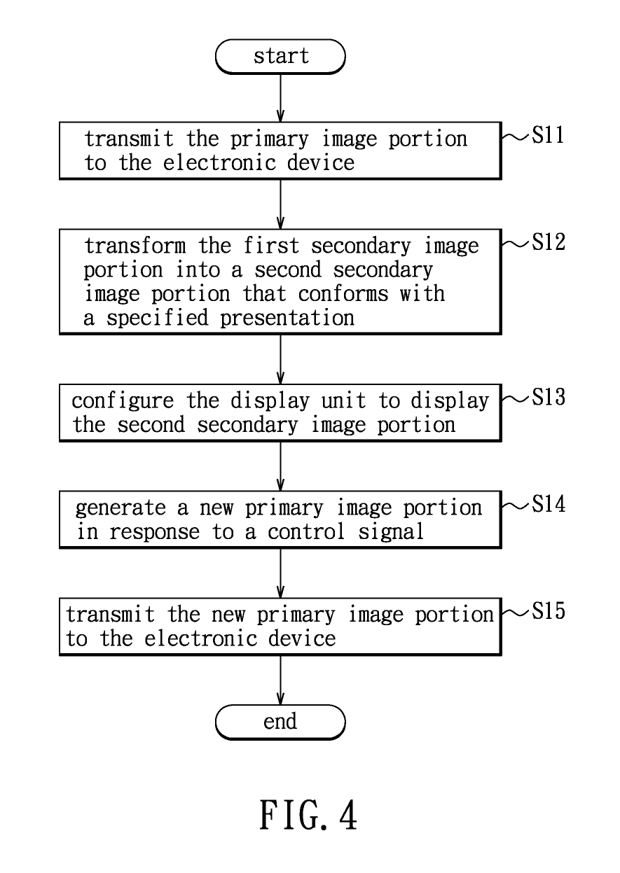

In step S112, the control unit 2 is operable to configure the display unit 1 to display the game image and the first button images serving as the main trigger objects. In step S113, the control unit 2 is operable to configure the display unit 1 to display the second button images that serve as the main trigger objects, and the flow goes to step S11 (see FIG. 4), in which the control unit 2 is operable to transmit the primary image portion 10 and the first secondary image portion 11 that is superimposed on the primary image portion 10 to the electronic device 200 for display by the electronic device 200 (as shown in FIG. 8). The flow then goes to step S12.

The sub-steps of step S14 will now be described in detail with reference to FIGS. 2, 10 and 13.

In step S151, the control unit 2 is operable to detect the control signal from the signal generator 5. In this case, the control signal is a touch control signal as a result of a touch event. The flow goes to step S152 when the touch control signal is detected, and goes back to step S151 when otherwise.

In step S152, the control unit 2 is operable to transmit the touch control signal to the kernel layer 80. The kernel layer 80 is configured to process the touch control signal and then to obtain a spatial point that is associated with a location of the display unit 1 touched by the user.

In step S153, the spatial point is then transmitted to the framework layer 81.

In step S154, the control unit 2 is operable to map the spatial point spatially onto one of the first button images on the first secondary image portion 11 through the framework layer 81, so as to establish a link between the spatial point and the corresponding one of the first button images.

Then, in step S155, the spatial point serves as a reference in a callback operation, in which the control unit 2 transmits the spatial point from the framework layer 81 to the application layer 82. Thus, the application layer 82 is notified that the specific operation button (e.g., the second D-pad 120, the second operation button (A) 121 or the second operation button (B) 122) is touched.

The flow then goes to step S156, in which the control unit 2 is operable to change appearance of the touched second button image through the framework layer 81. The second button image thus altered is then displayed by the display unit 1.

In step S157, the control unit 2 is operable to transmit a flag to the application layer 82 indicating that one of the second button images is touched, so as to enable triggering of the associated first button image. Thus, appearance of the associated first button image can be changed concurrently for informing the user of a detected touch event on the specific operation button.

In step S158, the control unit 2 is operable to generate a new primary image portion 10 based on the first and second button images through the application layer 82. It is noted that the kernel layer 80 is responsible for the steps 151 through 153, the framework layer 81 for the steps 154 and 157, and the application layer 82 for the step 158.

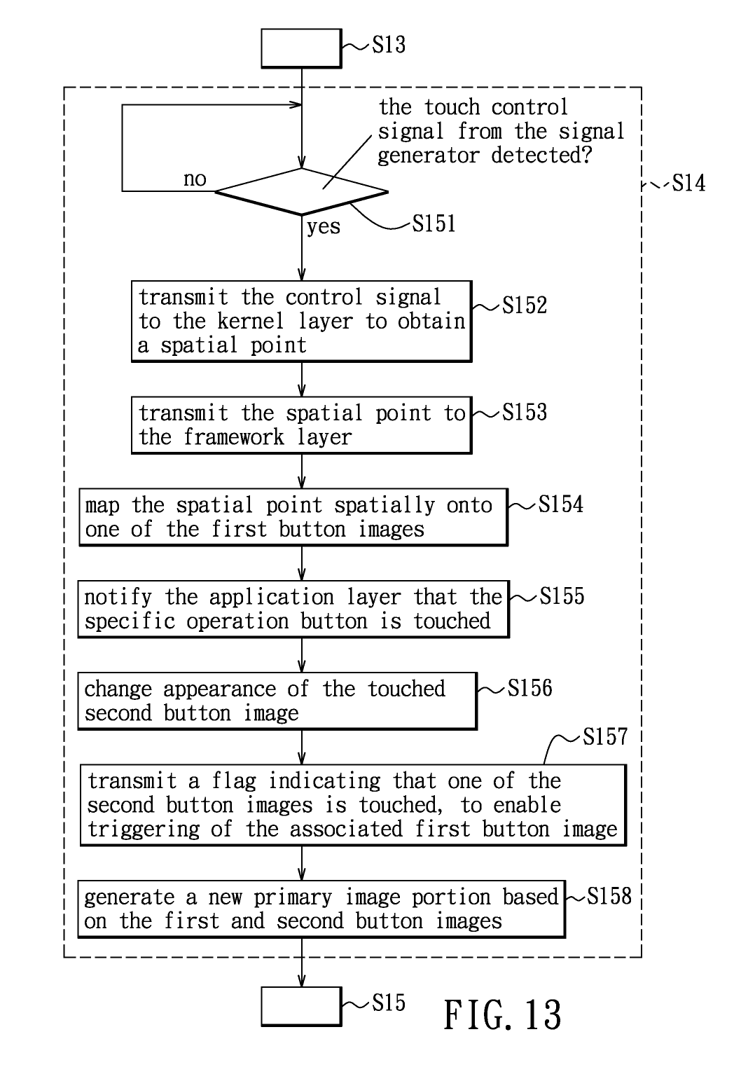

When each of the first secondary image portion 11 and the second secondary image portion 12 includes objects built in the Android operating system (see FIG. 9), the first and second objects can be triggered by a single event. In other words, the touch event of the second object on the user interface can directly trigger the associated first object. In the other hand, when each of the first secondary image portion 11 and the second secondary image portion 12 includes objects having new button layouts designed by the user or application developer, the first and second button images cannot be triggered by a single event. As a result, additional mapping operation (step S154 in FIG. 13) and transmission of the flag (step S157 in FIG. 13) are required to achieve the effect of triggering the first and second button images concurrently.

In this embodiment, the electronic device 200 can be configured to only display the primary image portion 10, as shown in FIG. 5. In such case, step S157 becomes redundant and can be omitted. The control unit 2 then generates the new primary image portion 10 based on the second button image in step S158 (see FIG. 13).

The following paragraphs are directed to the case in which an existing game is executed, and the game parameters cannot be changed. In such case, the second secondary image portion 12 includes objects having new button layouts, and the first secondary image portion 11 may include either objects having new button layouts or objects built in the Android operating system. For illustration purposes, in this embodiment, the first secondary image portion 11 includes objects built in the Android operating system. Thus, each of the first D-pad 110, the first operation button (A) 111 and the first operation button (B) 112 is defined as a distinct first object, while the second D-pad 120, the second operation button (A) 121 and the second operation button (B) 122 are three distinct second button images each associated with one of the first objects.

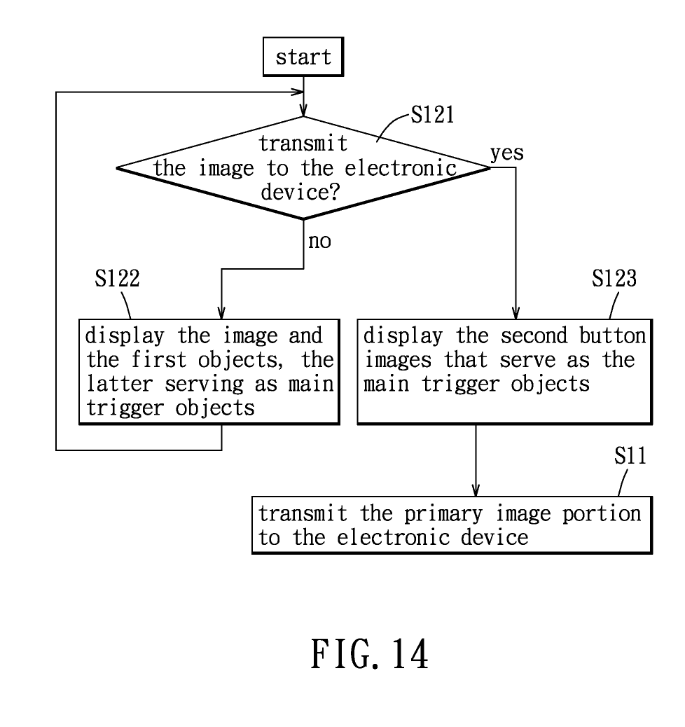

Referring to FIGS. 2, 4 and 14, when the existing game is executed and the image associated with the existing game is generated, the control unit 2 is operable to determine whether or not to transmit the image to the electronic device 200 in step S121. The flow goes to step S123 when the determination made in step S121 is affirmative, and goes to step S122 when otherwise.

In step S122, the control unit 2 is operable to configure the display unit 1 to display the game image and the first objects, the latter serving as main trigger objects. In step S123, the control unit 2 is operable to configure the display unit 1 to display the second button images that serve as the main trigger objects, and the flow goes to step S11 (see FIG. 4), in which the control unit 2 is operable to transmit the primary image portion 10 and optionally the first secondary image portion 11 that is superimposed on the primary image portion 10 to the electronic device 200 for display by the electronic device 200 (as shown in FIG. 8).

The sub-steps of step S14 will now be described in detail with reference to FIGS. 2, 10 and 15.

In step S161, the control unit 2 is operable to detect the touch control signal from the signal generator 5. The flow goes to step S162 when the touch control signal is detected, and goes back to step S161 when otherwise.

In step S162, the control unit 2 is operable to transmit the touch control signal to the kernel layer 80. The kernel layer 80 is configured to process the touch control signal and then to obtain a spatial point that is associated with a location of the display unit 1 touched by the user.

In step S163, the control unit 2 then transmits the spatial point to the framework layer 81.

Then, in step S164, a control process in the framework layer 81 is executed by the control unit 2 in a callback operation in the kernel layer 80. The control process is configured for establishing a link between each of the second image buttons and a corresponding one of the first objects, such that the touch event on one of the second image buttons leads to a simultaneous trigger event of the linked one of the first objects.

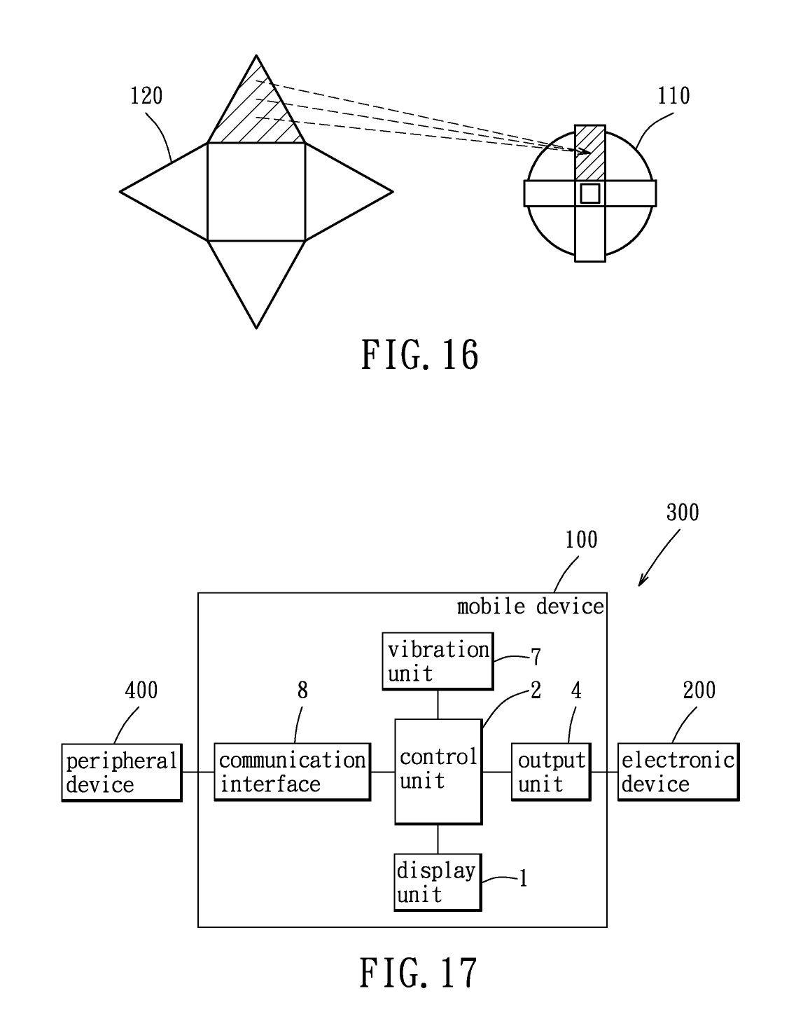

In this embodiment, an area of the second secondary image portion 12 is larger than that of the first secondary image portion 11 (the second D-pad 120 and the first D-pad 110 are illustrated in FIG. 16 as an example), and the control process is operable to map an area of a specific second button image on the second secondary image portion 12 to the center of a corresponding area of a linked one of the first objects on the first secondary image portion 11. Thus, when at least a part of the specific second button image is touched, the touch event is mapped to a corresponding location of the linked one of the first objects regardless of the exact location of the touch event.

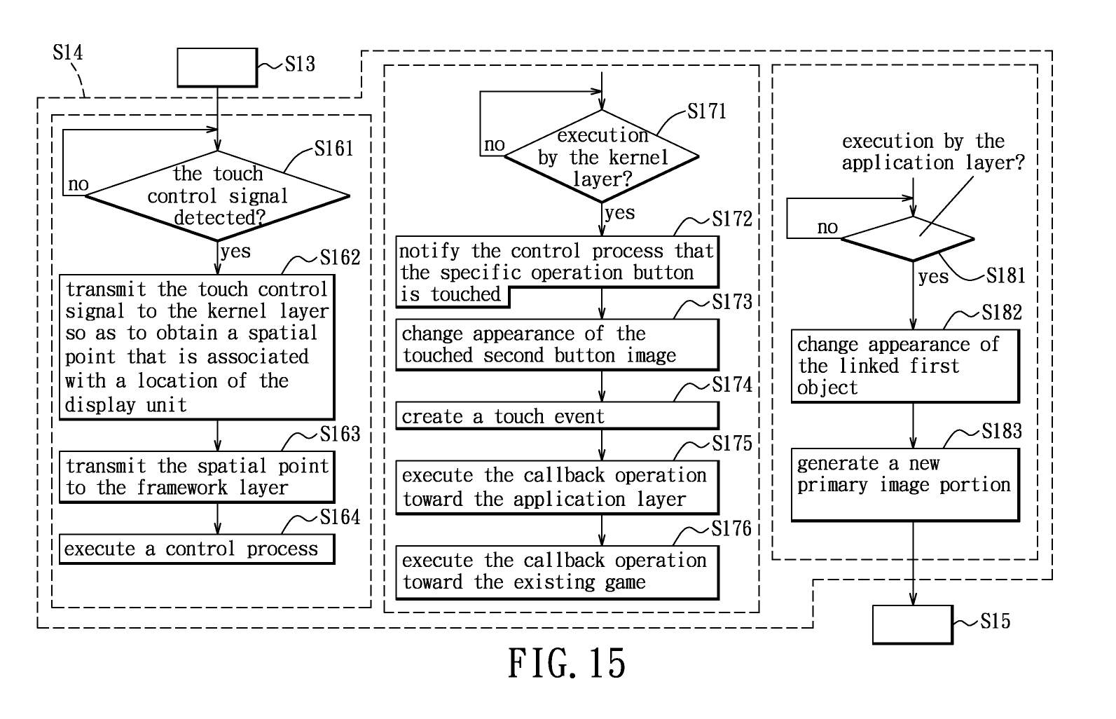

Referring back to FIG. 15, the control process is operable to allow the callback operation from the kernel layer 80 to execute the control process in step S171. When executed, the flow goes to step S172. Otherwise, the flow goes back to step S171 to await execution.

In step S172, the spatial point serves as a reference to the callback operation, such that the control process can be notified that the specific operation button (e.g., the second D-pad 120, the second operation button (A) 121 or the second operation button (B) 122) is touched.

The flow then goes to step S173, in which the control process is operable to change appearance of the touched second button image through the framework layer 81. The second button image thus altered is then displayed by the display unit 1.

In step S174, the control process is operable to create the touch event associated with the specific second button image so as to establish the link between the specific operation button and the corresponding first object.

The control process is then operable to execute the callback operation toward the application layer 82 and the existing game in step S175 and step S176, respectively.

The flow then goes to step S181, in which the callback operation from the framework layer 81 is to allow execution the existing game. When executed, the flow goes to step S182. Otherwise, the flow goes back to step S181 to await execution.

The control unit 2 is operable to change appearance of the linked first object in step S182, and is operable, in step S183, to generate a new primary image portion 10 based on the linked first object through the application layer 82.

In this embodiment, the electronic device 200 can be configured to only display the primary image portion 10, as shown in FIG. 5. In such case, step S182 becomes redundant and can be omitted.

In step S183 (see FIG. 13), the control unit 2 then generates the new primary image portion 10 based on the touched second button image.

It has been shown that the aforementioned procedures in combination the multilayer architecture are capable of processing the interaction between the mobile device 100 and the electronic device 200 in all cases involving both the new game and the existing game, and involving both objects built in the Android operating system and objects having new button layouts designed by the user or application developer.

### Second Embodiment

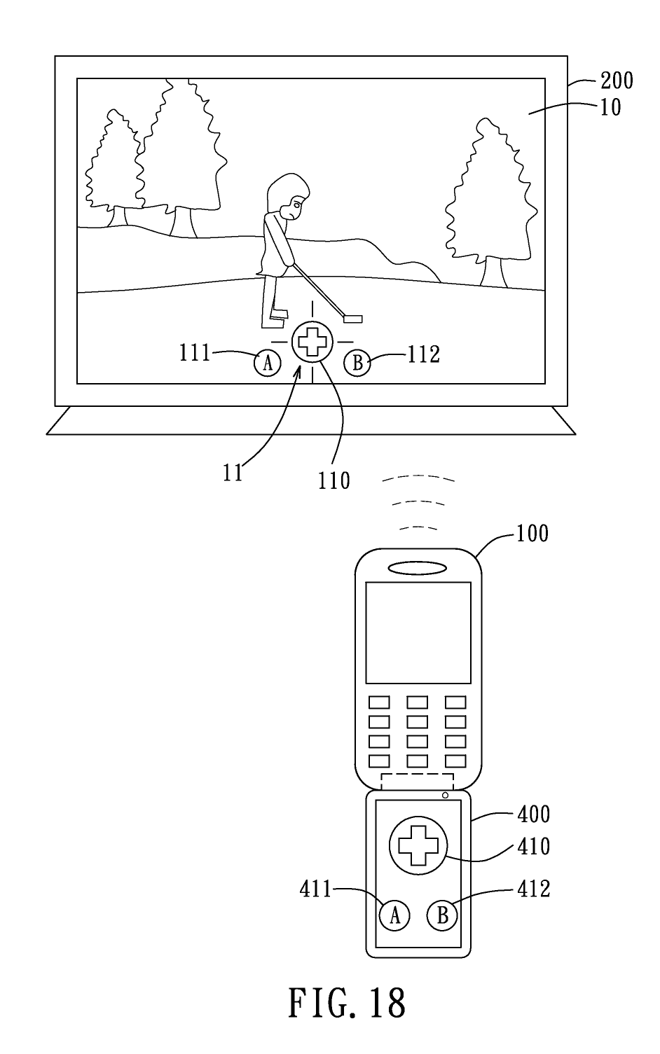

Reference is now made to FIG. 17, which illustrates the second preferred embodiment of an interactive system 300 according to the present invention. The interactive system 300 includes a mobile device 100 and an electronic device 200 that has a display function. Similar to the first preferred embodiment, the mobile device 100 is a smart phone, and the electronic device 200 is an LCD.

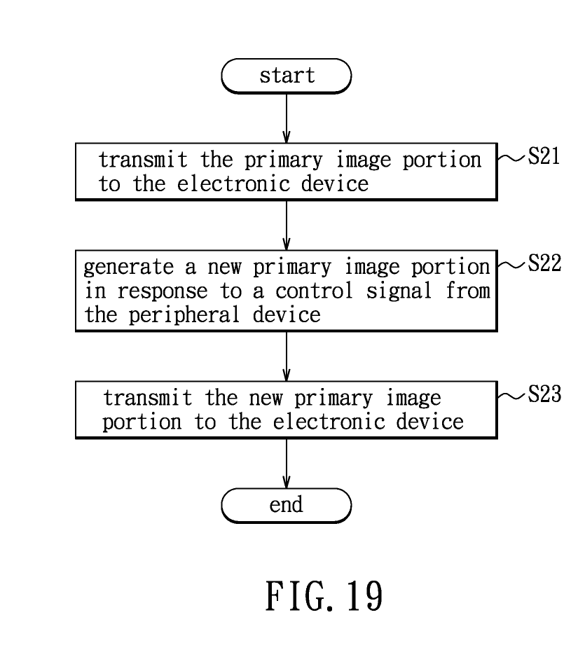

Further referring to FIG. 18, the mobile device 100 includes a display unit 1, a control unit 2 that is coupled to the display unit 1 and that is operable to control operations of other components of the mobile device 100, an output unit 4 that is coupled to the control unit 2, a vibration unit 7, and a communication interface 8.

The display unit 1 is for displaying an image, as shown in FIG. 3. The image is generated by the control unit 2 of the mobile device 100 that executes a program (e.g., a video game application, a widget or an office application), and includes a primary image portion 10 and a first secondary image portion 11 that is superimposed on the primary image portion 10. In this embodiment, the first secondary image portion 11 is a virtual button set that includes three button images, namely a first directional pad (D-pad) 110, a first operation button (A) 111 and a first operation button (B) 112.

The output unit 4 is operable to, upon being instructed by the control unit 2, transmit the primary image portion 10 to the electronic device 200 for display by the electronic device 200.

The communication interface 8 is for communication with a peripheral device 400 that is operatively coupled to the mobile device 100. In this embodiment, the peripheral device 400 includes a press key unit having a D-pad key 410, a first operation key 411 and a second operation key 412 that correspond respectively to the first D-pad 110, the first operation button (A) 111 and the first operation button (B) 112. The vibration unit 7 is operable to vibrate at a specified frequency when one of the operation keys of the press key unit is pressed. It is worth noting that, while each operation key of the press key unit is assigned a specific vibration frequency in this embodiment, the vibration frequency associated with each operation key of the press key unit can be user-configured.

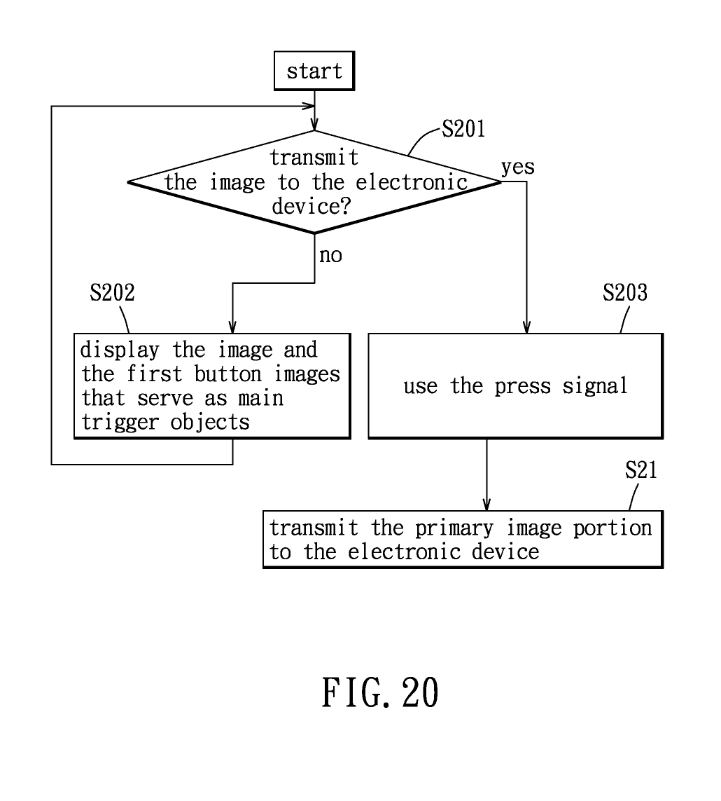

Referring to FIGS. 17 to 19, a method implemented by the mobile device 100 for interacting with the electronic device 200 according to this embodiment will now be described in detail.

In step S21, the control unit 2 of the mobile device 100 is operable to configure the output unit 4 to transmit the primary image portion 10 to the electronic device 200 for display by the electronic device 200.

In step S22, the control unit 2 of the mobile device 100 is operable to generate a new primary image portion 10 in response to a control signal from the peripheral device 400 that is operatively coupled to the mobile device 100. Unlike the first preferred embodiment, the user is operating the peripheral device 400, rather than the mobile device 100, to interact with the electronic device 200. Accordingly, the control signal is a press signal generated by the peripheral device 400, upon pressing the press key unit of the peripheral device 400.

Then, in step S23, the control unit 2 of the mobile device 100 is operable to configure the output unit 4 to transmit the new primary image portion 10 to the electronic device 200 for display by the electronic device 200 in real time. This serves as a response to user operation.

Setup of the interactive system 300 before performing step S21 and the flow of step S22, in which the control unit 2 of the mobile device 100 generates the new primary image portion 10 will now be described in detail in the following, with respect to both a new game and an existing game.

The following paragraphs are directed to the case in which a new game is executed. In this case, the first secondary image portion 11 includes objects having new button layouts designed by the user or application developer. Hence, the first D-pad 110, the first operation button (A) 111 and the first operation button (B) 112 of the first secondary image portion 11 are three distinct first button images.

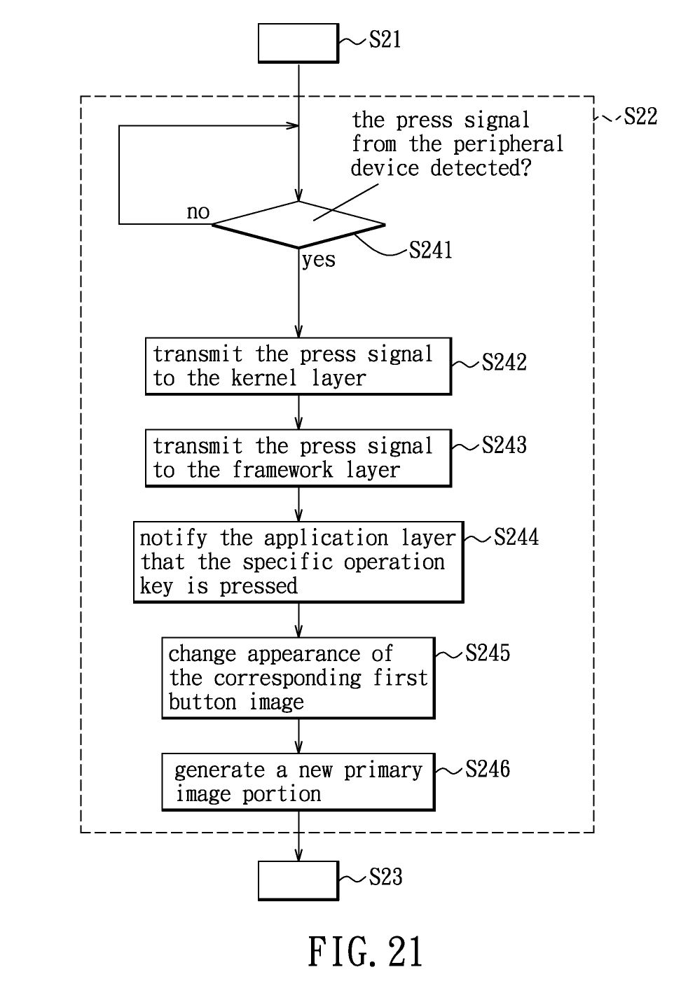

Referring to FIGS. 17, 19 and 20, when the new game is executed and the image associated with the new game is generated, the control unit 2 is operable to determine whether or not to transmit the game image to the electronic device 200 in step S201. The flow goes to step S203 when the determination made in step S201 is affirmative, and goes to step S202 when otherwise.

In step S202, the control unit 2 is operable to configure the display unit 1 to display the game image and the first button images that serve as the main trigger objects.

In step S203, the control unit 2 is operable to use the press signal from the peripheral device 400 as the main trigger object, and the flow goes to step S21, in which the control unit 2 is operable to transmit the primary image portion 10 and the first secondary image portion 11 that is superimposed on the primary image portion 10 to the electronic device 200 for display by the electronic device 200 (as shown in FIG. 18). The flow then goes to step S22.

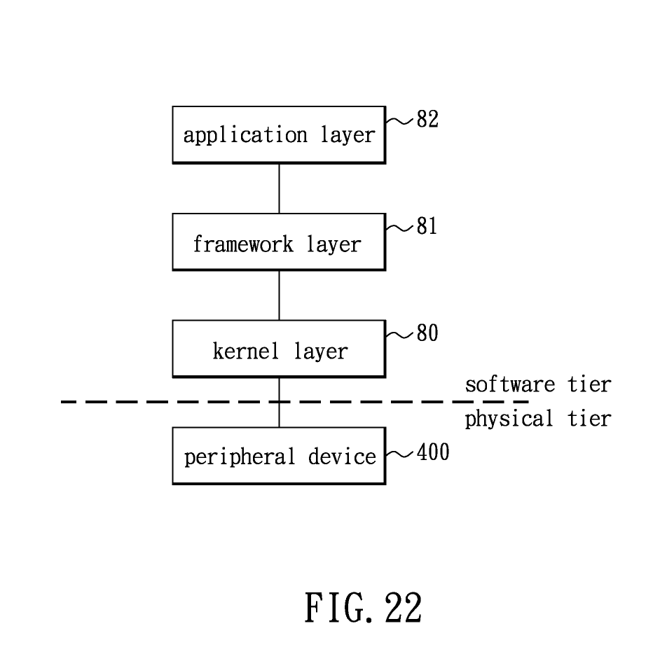

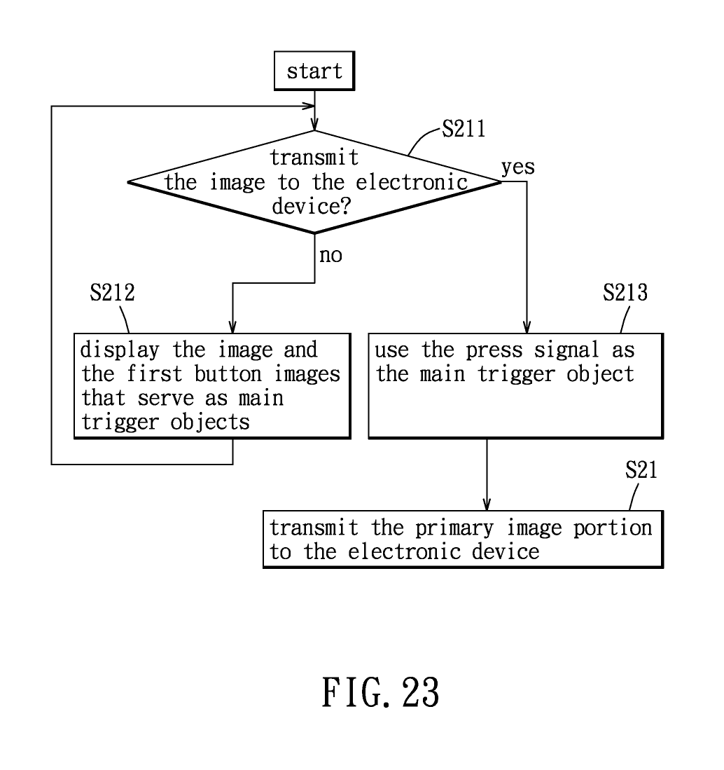

The of step S22 are described with further reference to FIG. 21. FIG. 22 illustrates a multilayer architecture of the interactive system 300 of this embodiment.

In step S241, the control unit 2 is operable to detect the press signal from the peripheral device 400. The flow goes to step S242 when the press signal is detected, and goes back to step S241 when otherwise.

In step S242, the control unit 2 is operable to transmit the press signal to the kernel layer 80.

In step S243, the kernel layer 80 is then configured to transmit the press signal to the framework layer 81.

In step S244, the press signal serves as a reference in a callback operation, in which the control unit 2 transmits the press signal from the framework layer 81 to the application layer 82. Thus the application layer 82 is notified that the specific operation key (e.g., the D-pad key 410, the first operation key 411 and the second operation key 412) is pressed.

The flow then goes to step S245, in which the control unit 2 is operable to change appearance of the corresponding first button image in the framework layer 81.

In step S246, the control unit 2 is operable to generate a new primary image portion 10 based on the first button image through the application layer 82. It is noted that the kernel layer 80 is responsible for the steps 241 through 243, the framework layer 81 for the steps 244 and 245, and the application layer 82 for the step 246.

In this embodiment, the electronic device 200 can be configured to only display the primary image portion 10. In such case, step S245 becomes redundant and can be omitted.

The following paragraphs are directed to the case in which an existing game is executed. Similar to the case with the new game, the first secondary image portion 11 includes objects having new button layouts designed by the user or application developer. Hence, the first D-pad 110, the first operation button (A) 111 and the first operation button (B) 112 of the first secondary image portion 11 are three distinct first button images.

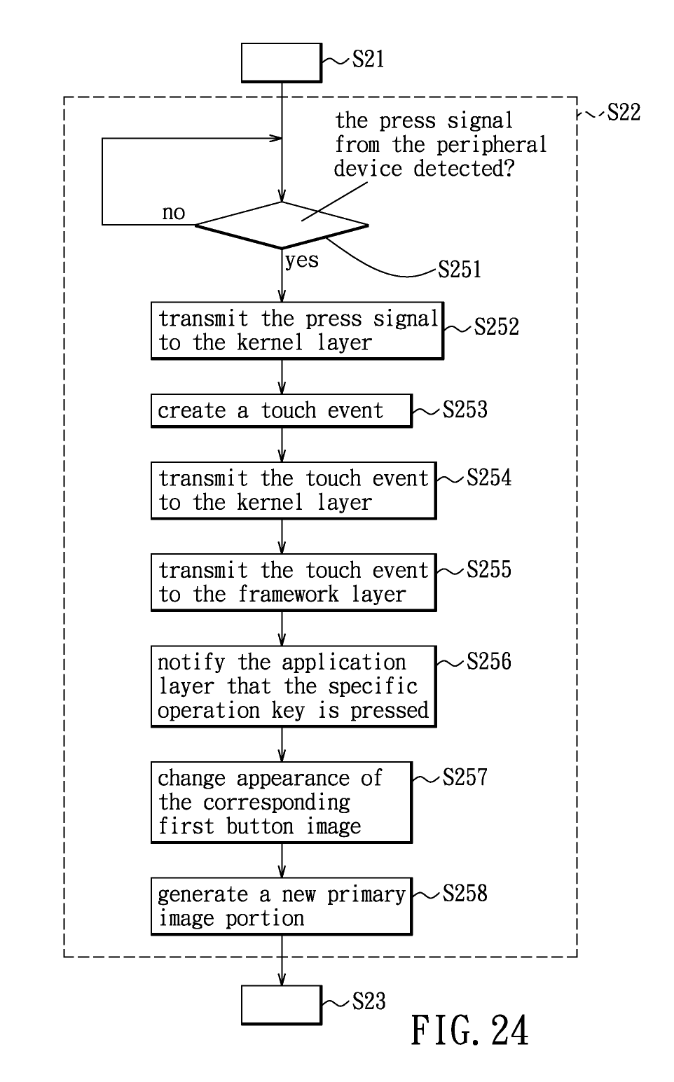

Referring to FIGS. 17, 19 and 23, when the existing game is executed and the image associated with the existing game is generated, the control unit 2 is operable to determine whether or not to transmit the game image to the electronic device 200 in step S211. The flow goes to step S203 when the determination made in step S211 is affirmative, and goes to step S212 when otherwise.

In step S212, the control unit 2 is operable to configure the display unit 1 to display the game image and the first button images that serve as main trigger objects.

In step S213, the control unit 2 is operable to use the press signal as the main trigger object, and the flow goes to step S21, in which the control unit 2 is operable to transmit the primary image portion 10 and the first secondary image portion 11 that is superimposed on the primary image portion 10 to the electronic device 200 for display by the electronic device 200 (as shown in FIG. 18). The flow then goes to step S22.

The sub-steps of step S22 are now described with further reference to FIGS. 17, 22 and 24.

In step S251, the control unit 2 is operable to detect the press signal from the peripheral device 400. The flow goes to step S252 when the press signal is detected, and goes back to step S251 when otherwise.

In step S252, the control unit 2 is operable to transmit the press signal to the kernel layer 80.

In step S253, the control unit 2 is further operable to create a touch event that can be subsequently mapped onto a corresponding one of the first button images.

In step S254, the touch event is then transmitted to the kernel layer 80.

In step S255, the touch event is transmitted to the framework layer 81 from the kernel layer 80.

In step S256, the touch event serves as a reference in a callback operation, in which the control unit 2 transmits the press signal from the framework layer 81 to the application layer 82. Thus, the application layer 82 is notified that the specific operation key (e.g., the D-pad key 410, the first operation key 411 or the second operation key 412) is pressed.

The flow then goes to step S257, in which the control unit 2 is operable to change appearance of the corresponding first button image through the framework layer 81.

In step S258, the control unit 2 is operable to generate a new primary image portion 10 based on the first button image in the application layer 82.

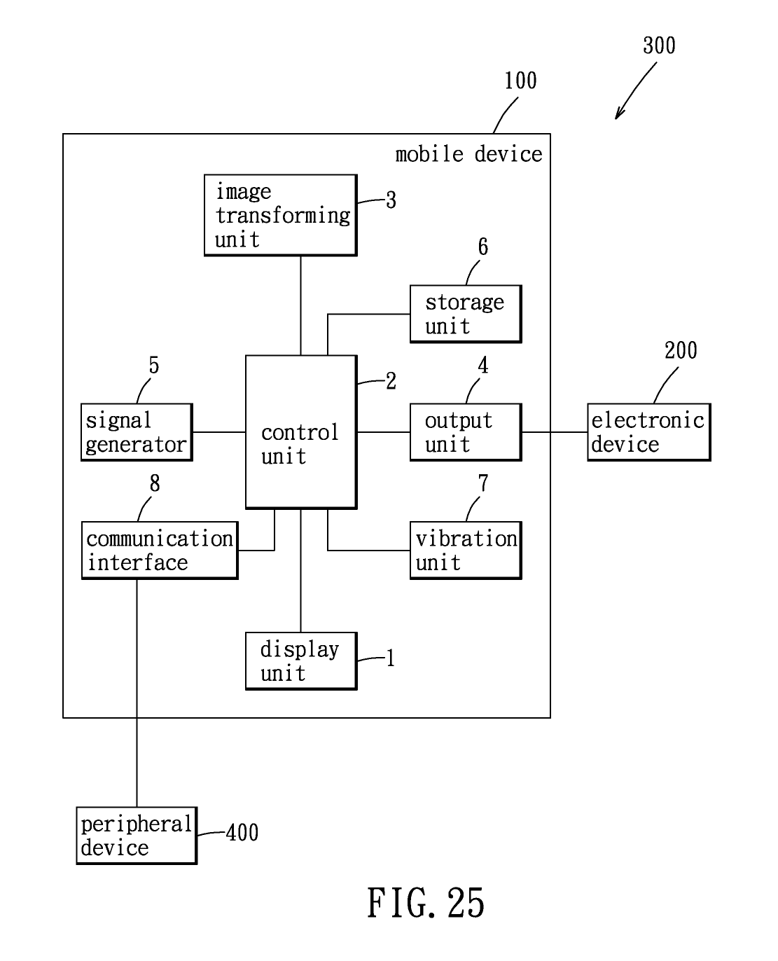

In this embodiment, the electronic device 200 can be configured to only display the primary image portion 10. In such case, step S257 becomes redundant and can be omitted (see FIG. 24).

It has been shown that the aforementioned procedures in combination with the multilayer architecture are capable of processing the interaction between the mobile device 100 and the electronic device 200 in all cases involving both the new game and the existing game. The second preferred embodiment has the same advantages as those of the first preferred embodiment.

### Third Embodiment

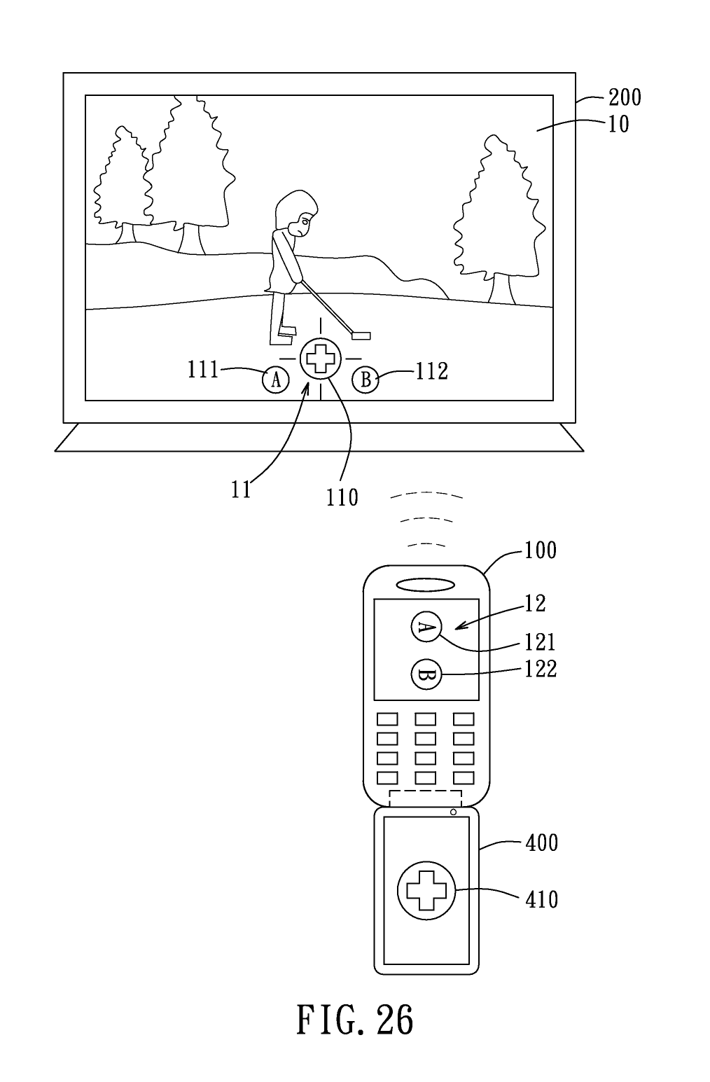

Reference is now made to FIG. 25, which illustrates the third preferred embodiment of an interactive system 300 according to the present invention. The interactive system 300 includes a mobile device 100 and an electronic device 200 that has a display function. Similar to the previous embodiments, the mobile device 100 is a smart phone, and the electronic device 200 is an LCD.

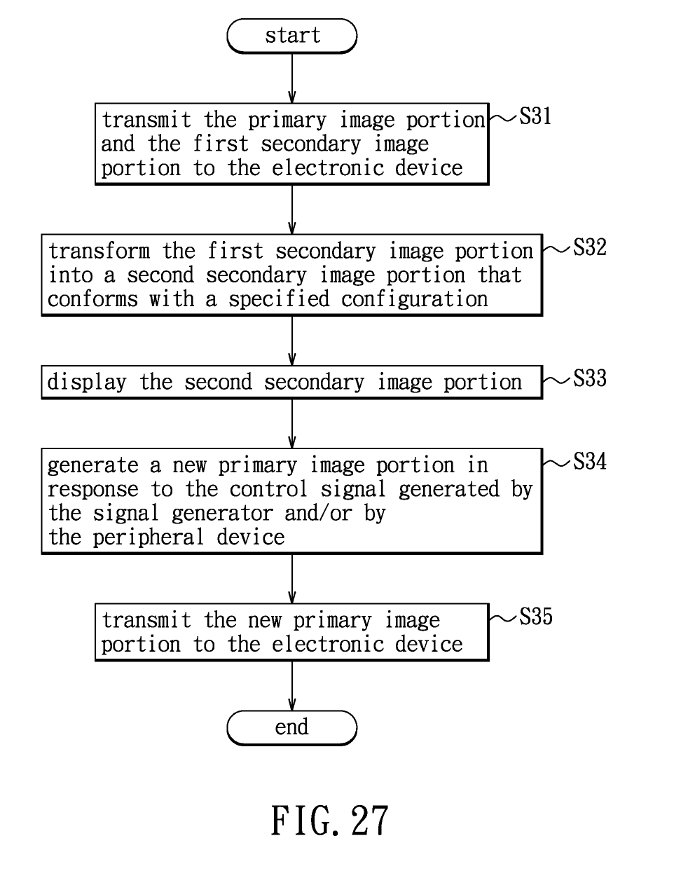

Further referring to FIG. 26, the mobile device 100 includes a display unit 1, a control unit 2 that is coupled to the display unit 1 and that is operable to control operations of other components of the mobile device 100, an image transforming unit 3 that is coupled to the control unit 2, an output unit 4, a signal generator 5, a storage unit 6, a vibration unit 7, and a communication interface 8. Since operations of the components of the mobile device 100 in this embodiment are basically similar to the operations in the previous embodiments, detailed descriptions thereof are omitted herein for the sake of brevity. The image displayed by the display unit 1 includes a primary image portion 10 and a first secondary image portion 11 that is superimposed on the primary image portion 10, and the first secondary image portion 11 is a virtual button set that includes three button images, namely a first directional pad (D-pad) 110, a first operation button (A) 111 and a first operation button (B) 112. However, the second secondary image portion 12 that is transformed by the image transforming unit 3 only includes a second operation button (A) 121 and a second operation button (B) 122, that are associated respectively with the first operation button (A) 111 and the first operation button (B) 112 of the first secondary image portion 11, and the peripheral device 400 operatively coupled to the mobile device 100 through the communication interface 8 only includes a D-pad key 410. That is, the display unit 1 of the mobile device 100 and the peripheral device 400 cooperate to provide the operation buttons used in this embodiment, and the operation buttons in the first secondary image portion 11 can be triggered by both a touch event and a press event.

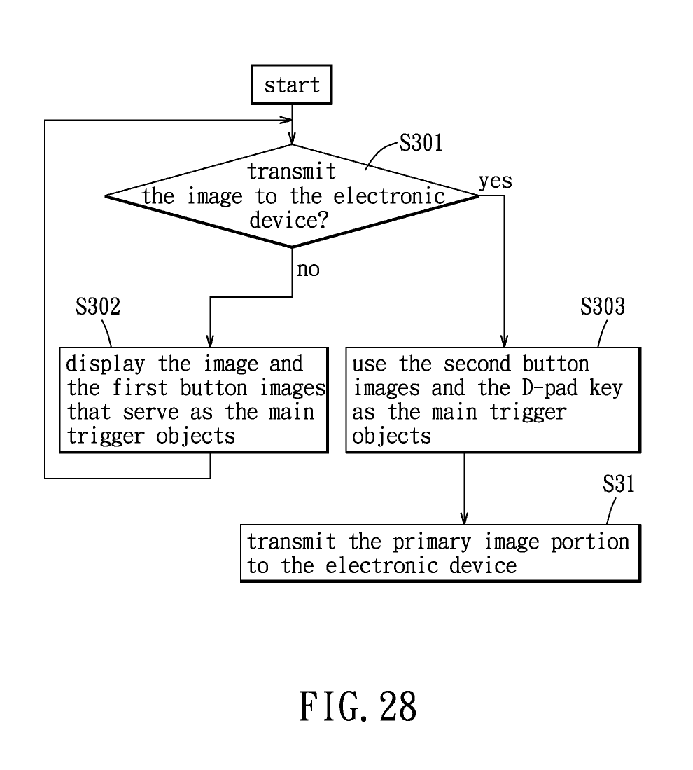

Further referring to FIG. 27 based on FIGS. 25-26, a method implemented by the mobile device 100 for interacting with the electronic device 200 will now be described in detail.

In step S31, the control unit 2 of the mobile device 100 is operable to configure the output unit 4 to transmit the primary image portion 10 and the first secondary image portion 11 to the electronic device 200 for display by the electronic device 200.

In step S32, the control unit 2 of the mobile device 100 is operable to transform the first secondary image portion 11 into a second secondary image portion 12 that conforms with a specified presentation. In this embodiment, the configuration of the second secondary image portion 12 (e.g., size, location and shape) can be specified by the user via the user interface of the mobile device 100 (examples of which are shown in FIG. 6). The specified presentation can be stored in the storage unit 6, and can serve as a default configuration for subsequent use.

In step S33, the control unit 2 of the mobile device 100 is operable to configure the display unit 1 to display the second secondary image portion 12. That is, the primary image portion 10 and the second secondary image portion 12 are displayed by the electronic device 200 and the mobile device 100, respectively.

In step S34, the control unit 2 of the mobile device 100 is operable to generate a new primary image portion 10 in response to the control signal generated by the signal generator 5 and/or by the peripheral device 400 as a result of user operation (e.g., touch event and/or press event).

Then, in step S35, the control unit 2 of the mobile device 100 is operable to configure the output unit 4 to transmit the new primary image portion 10 to the electronic device 200 for display by the electronic device 200 in real time. This serves as a response to the user operation.

Setup of the interactive system 300 before performing step S31 and the flow of step S34, in which the control unit 2 of the mobile device 100 generates the new primary image portion 10 will now be described in detail in the following, with respect to both a new game and an existing game.

The following paragraphs are directed to the case in which a new game is executed. In this case, as shown in FIG. 26, the first secondary image portion 11 includes objects having new button layouts designed by the user or application developer. Hence, the first D-pad 110, the first operation button (A) 111 and the first operation button (B) 112 of the first secondary image portion 11 are three distinct first button images, and the D-pad key 410, the second operation button (A) 121 and the second operation button (B) 122 are associated respectively with the first D-pad 110, the first operation button (A) 111 and the first operation button (B) 112, where the second operation button (A) 121 and the second operation button (B) 122 are two distinct second button images.

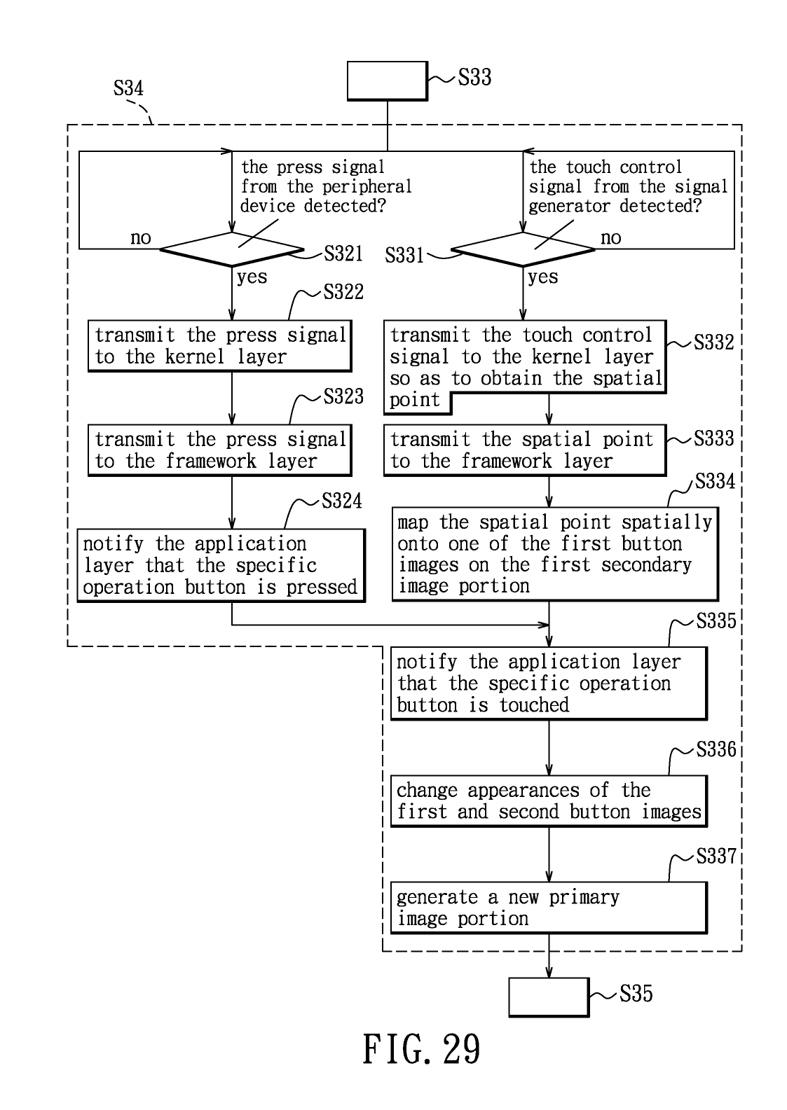

Referring to FIGS. 25, 27 and 28, when the new game is executed and the image associated with the new game is generated, the control unit 2 is operable to determine whether or not to transmit the game image to the electronic device 200 in step S301. The flow goes to step S303 when the determination made in step S301 is affirmative, and goes to step S302 when otherwise.

In step S302, the control unit 2 is operable to configure the display unit 1 to display the image and the first button images that serve as the main trigger objects.

In step S303, the control unit 2 is operable to use the second button images and the D-pad key 410 as the main trigger objects, and the flow goes to step S31, in which the control unit 2 is operable to transmit the primary image portion 10 and the first secondary image portion 11 that is superimposed on the primary image portion 10 to the electronic device 200 for display by the electronic device 200 (as shown in FIG. 26). The flow then goes to step S32.

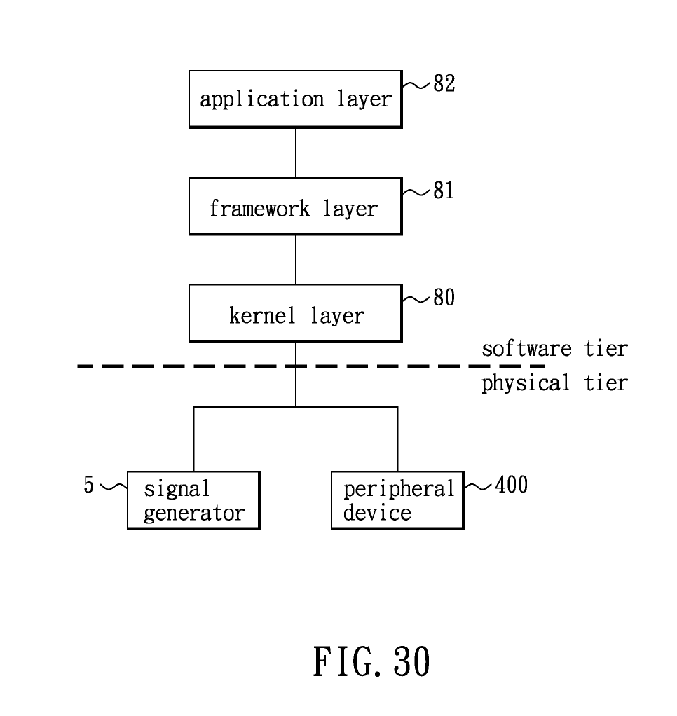

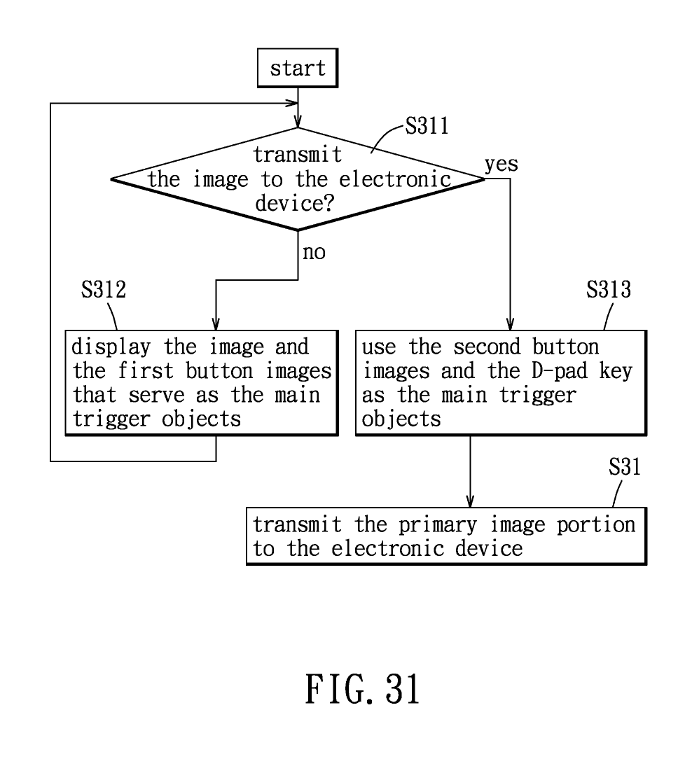

The sub-steps of step S34 are now described with further reference to FIG. 29 based on FIG. 25. FIG. 30 illustrates a multilayer architecture of the interaction system 300 of this embodiment.

In step S321, the control unit 2 is operable to detect the press signal from the peripheral device 400. The flow goes to step S322 when the press signal is detected, and goes back to step S321 when otherwise.

In step S322, the control unit 2 is operable to transmit the press signal to the kernel layer 80.

In step S323, the kernel layer 80 is then configured to transmit the press signal to the framework layer 81.

Instep S324, the press signal serves as a reference in a callback operation, in which the control unit 2 transmits the press signal from the framework layer 81 to the application layer 82. Thus, the application layer 82 is notified that the specific operation key (e.g., the D-pad key 410) is actuated.

In addition to detecting the press event of the peripheral device 400, the control unit 2 is further operable to detect the touch event of the display unit 1 concurrently. The procedure is described below.

In step S331, the control unit 2 is operable to detect the touch control signal from the signal generator 5. The flow goes to step S332 when the touch control signal is detected, and goes back to step S331 when otherwise.

In step S332, the control unit 2 is operable to transmit the touch control signal to the kernel layer 80. The kernel layer 80 is configured to process the touch control signal and to obtain the spatial point that is associated with a location of the display unit 1 touched by the user.

In step S333, the control unit 2 then transmits the spatial point to the framework layer 81.

Then, in step S334, the control unit 2 is operable to map the spatial point spatially onto one of the first button images on the first secondary image portion 11 through the framework layer 81, so as to establish a link between the spatial point and the corresponding first button image.

Then, in step S335, the spatial point serves as a reference in a callback operation, in which the control unit 2 transmits the spatial point from the framework layer 81 to the application layer 82. Thus, the application layer 82 is notified that the specific operation button (e.g., the second operation button (A) 121 or the second operation button (B) 122) is touched.

After step S324 and/or S335, the flow goes to step S336, in which the control unit 2 is operable to change appearances of the first and second button images through the framework layer 81. The second button image thus altered is then displayed by the display unit 1.

In step S337, the control unit 2 is operable to generate a new primary image portion 10 based on the first and second button images through the application layer 82.

In this embodiment, the electronic device 200 can be configured to only display the primary image portion 10. In such case, the control unit 2 changes appearance of the touched second button image in step S336, and generates the new primary image portion 10 based on the touched second button image in step S337.

The following paragraphs are directed to the case in which an existing game is executed, and the game parameters cannot be changed. In such case, as shown in FIG. 26, the first D-pad 110, the first operation button (A) 111 and the first operation button (B) 112 of the first secondary image portion 11 serve as three distinct first button images, and the D-pad key 410, the second operation button (A) 121 and the second operation button (B) 122 are associated respectively with the first D-pad 110, the first operation button (A) 111 and the first operation button (B) 112, where the second operation button (A) 121 and the second operation button (B) 122 are two distinctive second button images.

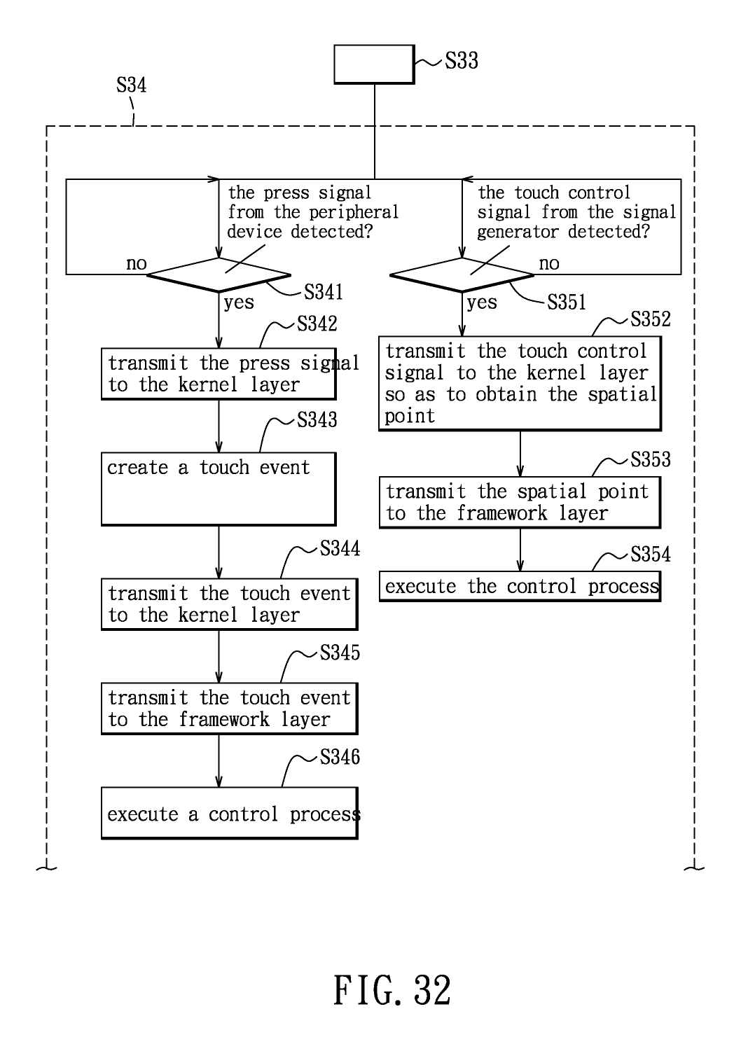

Referring to FIGS. 25, 27 and 31, when the existing game is executed and the image associated with the existing game is generated, the control unit 2 is operable to determine whether or not to transmit the game image to the electronic device 200 in step S311. The flow goes to step S313 when the determination made in step S311 is affirmative, and goes to step S312 when otherwise.

In step S312, the control unit 2 is operable to configure the display unit 1 to display the game image and the first button images that serve as the main trigger objects. In step S313, the control unit 2 is operable to use the second button images and the D-pad key 410 as the main trigger objects, and the flow goes to step S21, in which the control unit 2 is operable to transmit the primary image portion 10 and the first secondary image portion 11 that is superimposed on the primary image portion 10 to the electronic device 200 for display by the electronic device 200 (as shown in FIG. 26). The flow then goes to step S32.

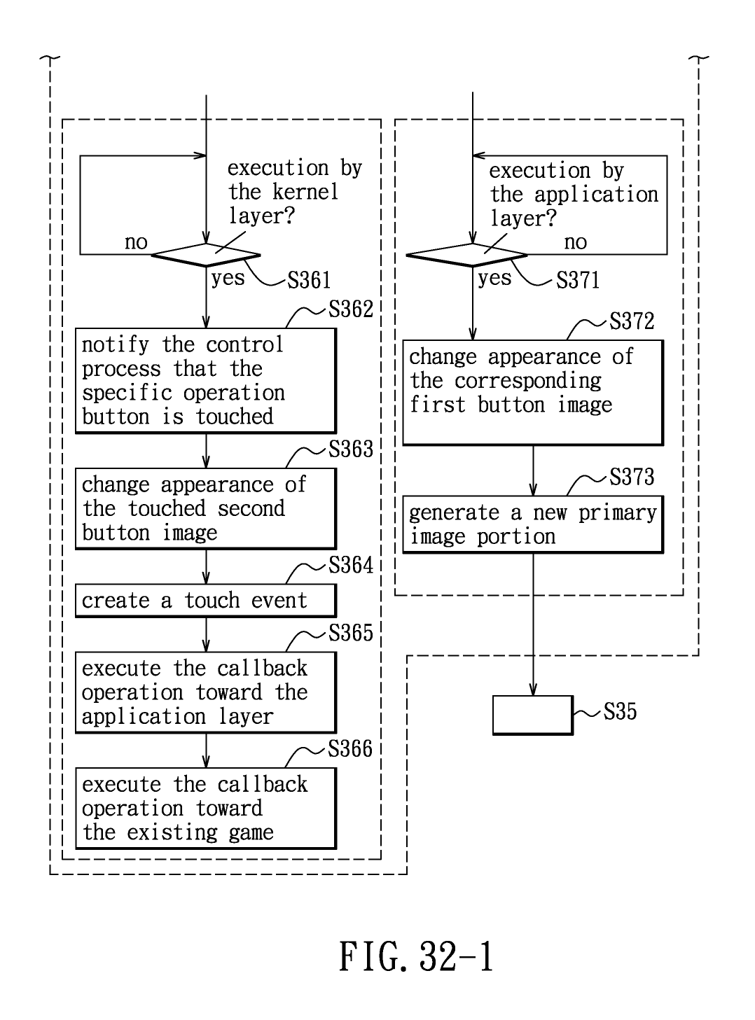

The sub-steps of step S34 will now be described with further reference to FIGS. 30 and 32 based on FIG. 25.

In step S341, the control unit 2 is operable to detect the press signal from the peripheral device 400. The flow goes to step S342 when the press signal is detected, and goes back to step S341 when otherwise.

In step S342, the control unit 2 is operable to transmit the press signal to the kernel layer 80. The control unit 2 is further operable to create a touch event that can be subsequently mapped onto a corresponding one of the first button images in step S343. The touch event is then transmitted to the kernel layer 80 in step S344 and transmitted to the framework layer 81 in step S345.

Then, in step S346, a control process is executed by the control unit 2 in a callback operation in the kernel layer 80.

In addition to detecting the press event of the peripheral device 400, the control unit 2 is further operable to detect the touch event of the display unit 1 concurrently. The procedure is described below.

In step S351, the control unit 2 is operable to detect the touch control signal from the signal generator 5. The flow goes to step S352 when the touch control signal is detected, and goes back to step S351 when otherwise.

In step S352, the control unit 2 is operable to transmit the touch control signal to the kernel layer 80. The kernel layer 80 is configured to process the touch control signal and to obtain a spatial point that is associated with a location of the display unit 1 touched by the user.

In step S353, the control unit 2 then transmits the spatial point to the framework layer 81.

Then, in step S354, the control process in the framework layer 81 is executed by the control unit 2 in a callback operation in the kernel layer 80.

The control process is operable to allow the callback operation from the kernel layer 80 to execute the control process in step S361. When executed, the flow goes to step S362. Otherwise, the flow goes back to step S361 to await execution.

In step S362, the spatial point serves as a reference to the callback operation, such that the control process can be notified that the specific operation button (e.g., the second operation button (A) 121 or the second operation button (B) 122) is touched.

The flow then goes to step S363, in which the control process is operable to change appearance of the touched second button image through the framework layer 81. The second button image thus altered is then displayed by the display unit 1.

In step S364, the control process is operable to create the touch event associated with the specific second button image so as to establish the link between the specific operation button and the corresponding first button image. The control process is then operable to execute the callback operation toward the application layer 82 and the existing game instep S365 and step S366, respectively. The flow then goes to step S371, in which the callback operation from the framework layer 81 to is to allow execution of the existing game. When executed, the flow goes to step S372. Otherwise, the flow goes back to step S371 to await execution.

The control unit 2 is operable to change appearance of the corresponding first button image based on the touch event in step S372, and is operable, in step S373, to generate a new primary image portion 10 based on the linked first object through the application layer 82.

In this embodiment, the electronic device 200 can be configured to only display the primary image portion 10. In such case, step S372 becomes redundant and can be omitted. The control unit 2 then generates the new primary image portion 10 based on the second button image in step S373.

It has been shown that the aforementioned procedures in combination with the multilayer architecture are capable of processing the interaction between the mobile device 100 and the electronic device 200 in all cases involving both the new game and the existing game.

### Fourth Embodiment

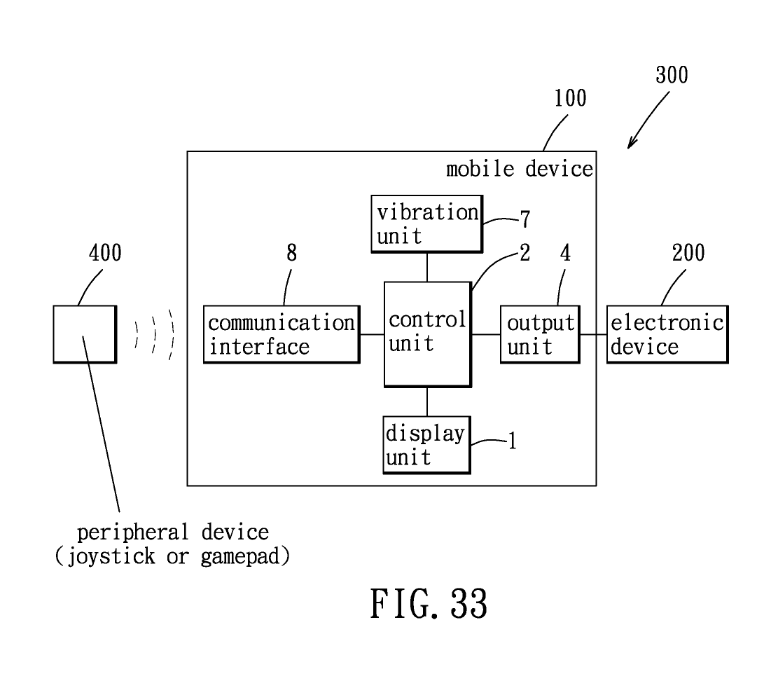

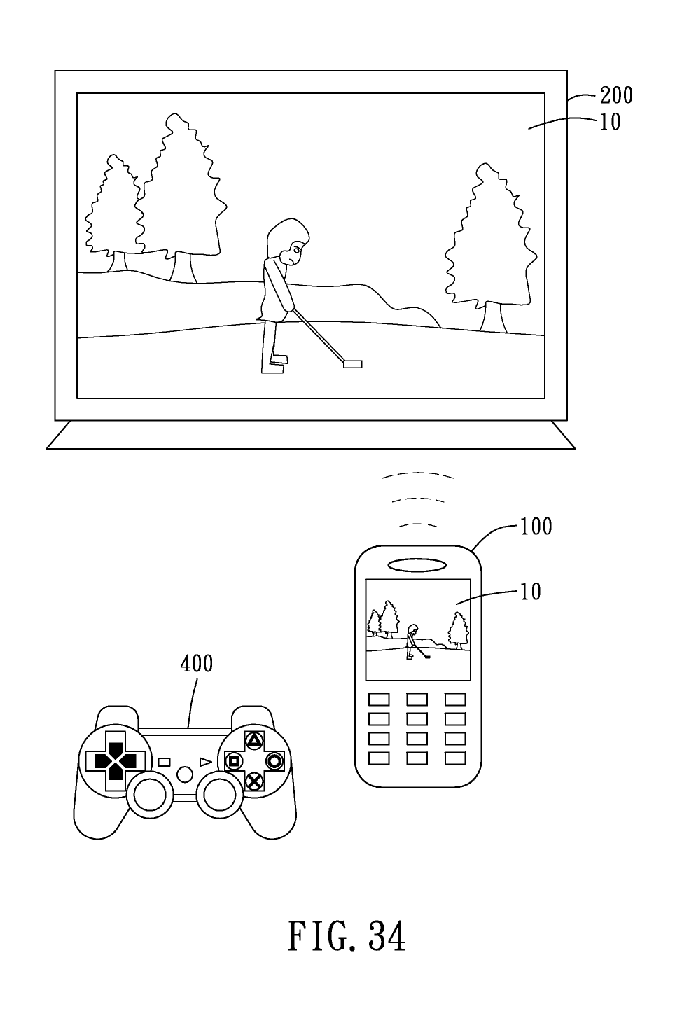

Reference is now made to FIGS. 33 and 34, which illustrate the fourth preferred embodiment of an interactive system 300 according to the present invention. The interactive system 300 has a structure similar to that of the second preferred embodiment. The main difference between this embodiment and the second preferred embodiment resides in the configuration of the peripheral device 400. In this embodiment, the peripheral device 400 is a joystick or gamepad that communicates wirelessly (e.g., using Bluetooth technology) with the mobile device 100 through the communication interface 8. Hence, the control signal can be generated based on operation of the joystick or gamepad and transmitted to the mobile device 100 thereafter. The control unit 2 is then operable to generate the new primary image portion 10 according to the control signal, and to configure the output unit 4 to transmit the new primary image portion 10 to the electronic device 200 for display by the electronic device 200. The fourth preferred embodiment has the same advantages as those of the previous embodiments.

### Fifth Embodiment

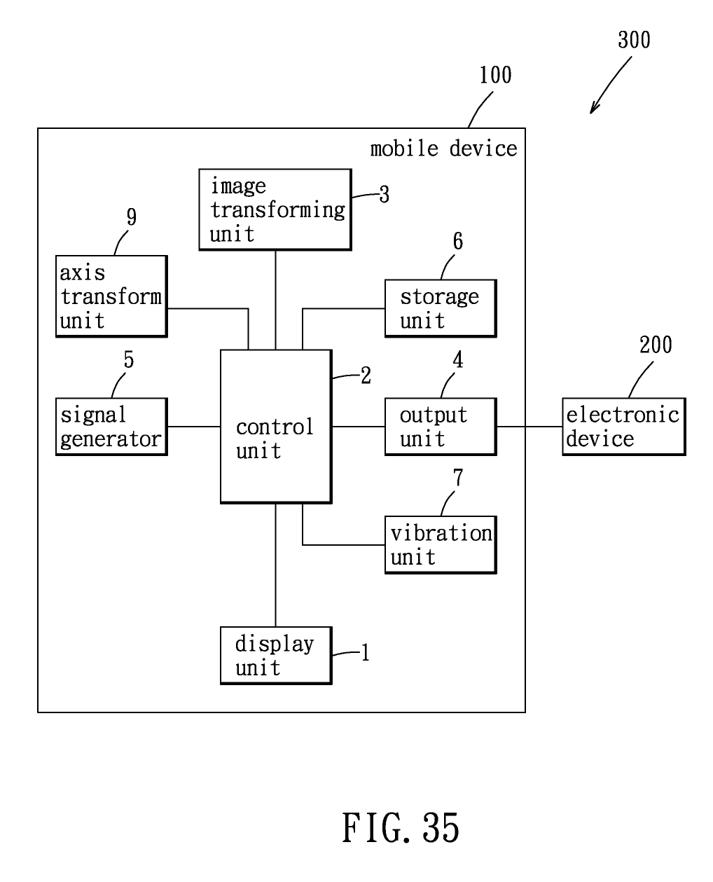

Reference is now made to FIG. 35, which illustrates the fifth preferred embodiment of an interactive system 300 according to the present invention. The interactive system 300 has a structure similar to that of the first preferred embodiment. The main difference between this embodiment and the first preferred embodiment resides in the following. In this embodiment, the mobile device 100 further includes an axis transform unit 9 that is coupled to both the signal generator 5 and the control unit 2. The axis transform unit 9 is for performing a coordinate axis transform according to the second secondary image portion 12. The signal generator 5 further includes a motion detector that is configured to generate a motion signal in response to movement of the mobile device 100 (e.g., displacement and/or rotation).

Compared with the first preferred embodiment, the mobile device 100 in this embodiment is operable to interact with the electronic device 200 in real time via the movement of the mobile device 100, instead of the touch event. Such interaction configuration can be further categorized into two modes, namely an air mouse mode and an axis transformation mode. In the air mouse mode, the mobile device 100 is operable as a mouse for controlling a cursor displayed on the electronic device 200 via movement of the mobile device 100. In the axis transformation mode, the mobile device 100 is operable to perform a change of page orientation (e.g., change from portrait mode to landscape mode, or vise versa) for accommodating different game requirements.

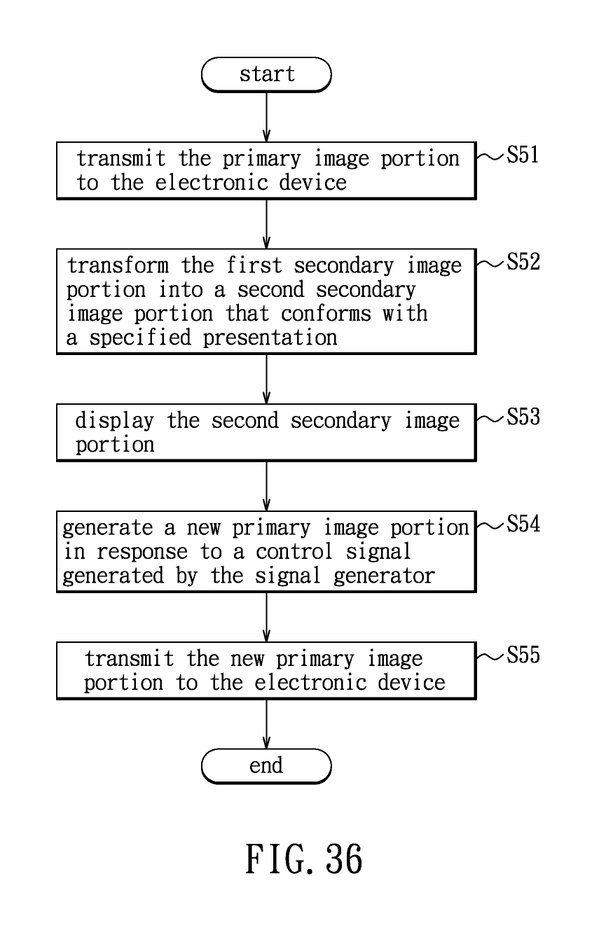

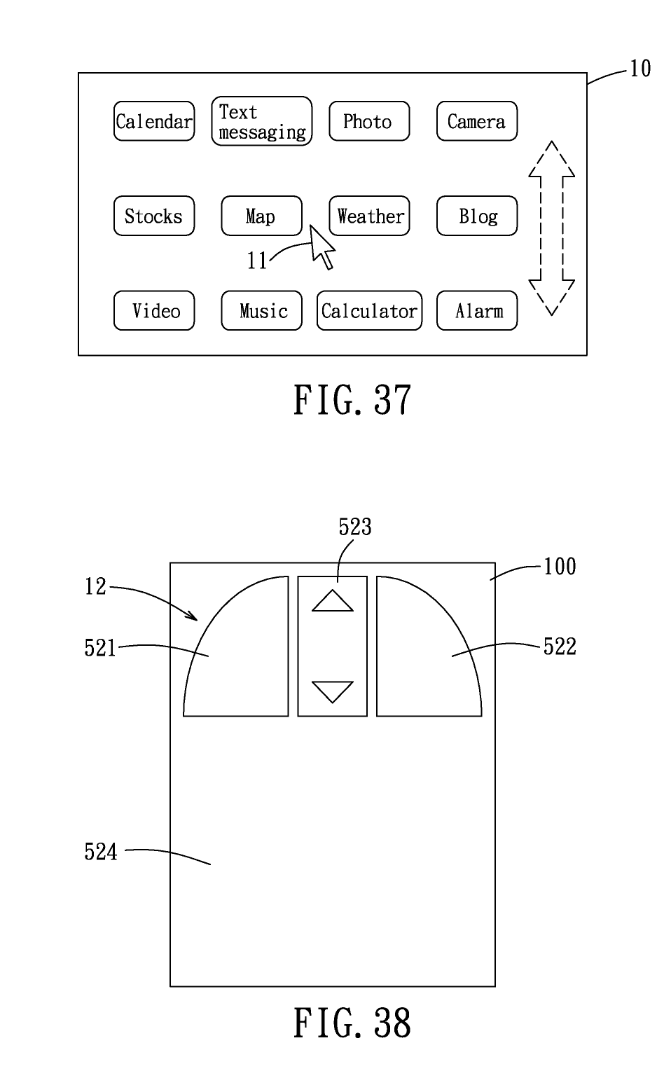

Further referring to FIG. 36, a method implemented by the mobile device of this embodiment for interacting with the electronic device 200 will now be described in detail.

In step S51, the control unit 2 of the mobile device 100 is operable to configure the output unit 4 to transmit the primary image portion 10 to the electronic device 200 for display by the electronic device 200.

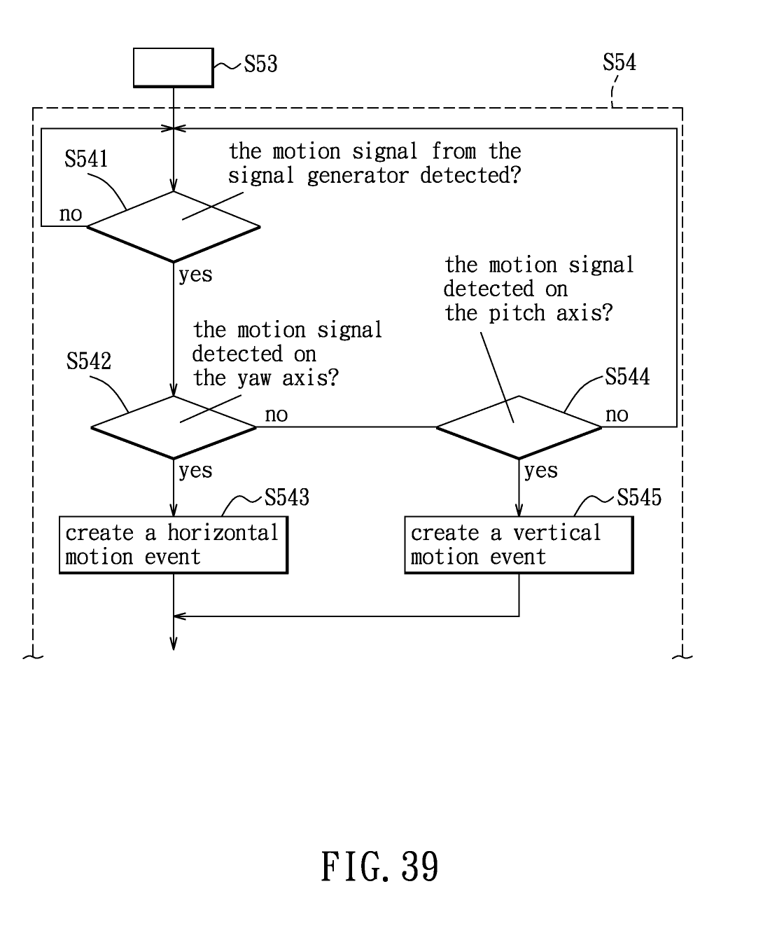

In step S52, the control unit 2 of the mobile device 100 is operable to transform the first secondary image portion 11 into a second secondary image portion 12 that conforms with a specified presentation (see FIG. 38).

In step S53, the control unit 2 of the mobile device 100 is operable to configure the display unit 1 to display the second secondary image portion 12.

In step S54, the control unit 2 of the mobile device 100 is operable to generate a new primary image portion 10 in response to a control signal generated by the signal generator 5 as a result of user operation.

Then, in step S55, the control unit 2 of the mobile device 100 is operable to configure the output unit 4 to transmit the new primary image portion 10 to the electronic device 200 for display by the electronic device 200 in real time. This serves as a response to the user operation.

The sub-steps of step S54, in which the control unit 2 of the mobile device 100 generates the new primary image portion 10, will now be described in detail in the following, with respect to the air mouse mode and the axis transformation mode.

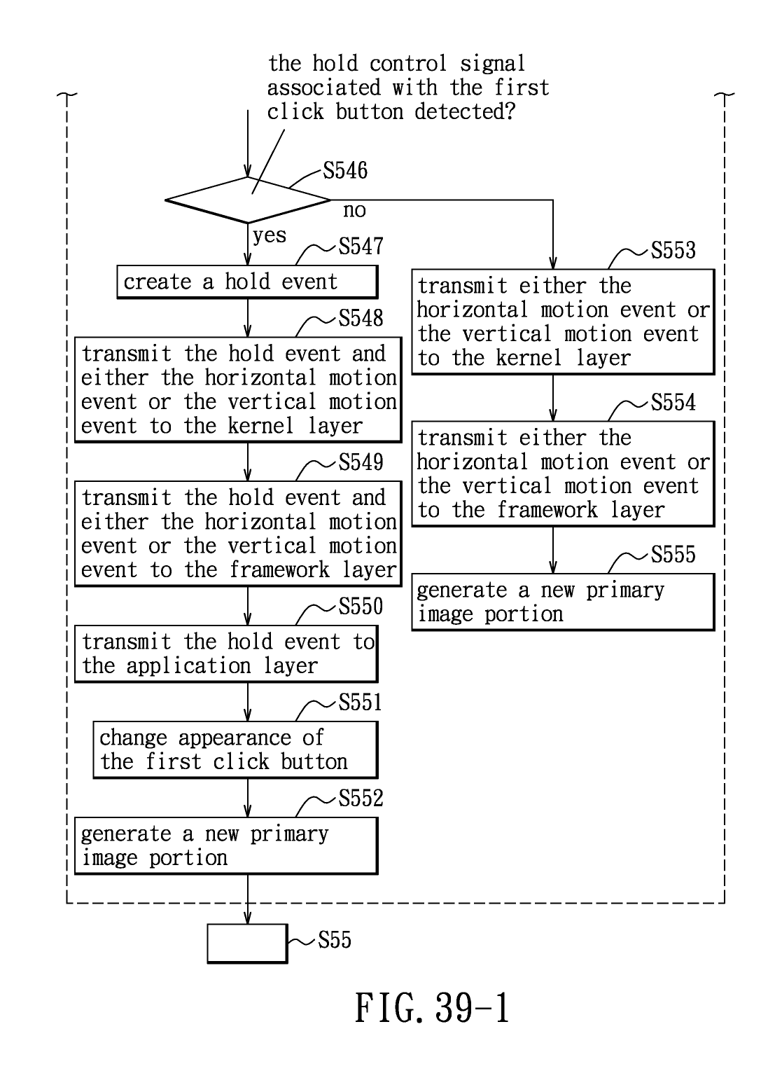

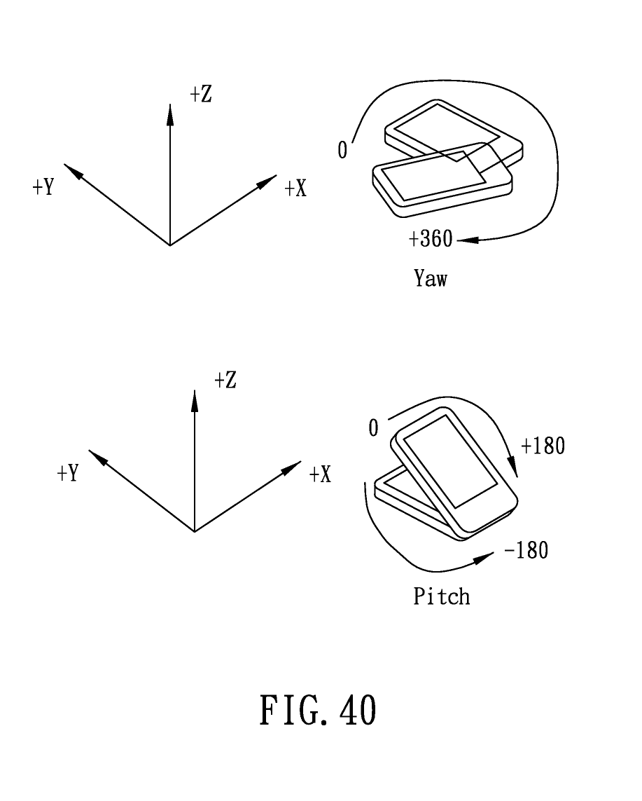

The following paragraphs are directed to the case of the air mouse mode, with further reference to FIG. 39. The interactive system 300 also has a multilayer architecture similar to that shown in FIG. 10.

In this case, the primary image portion 10 is an icon menu for home-screen of a smart phone, or a springboard of the iPhone OS, the first secondary image portion 11 is a cursor, and the second secondary image includes a first click button 521, a second click button 522, a scroll control button 523 and a touchpad area 524.

In step S541, the control unit 2 is operable to detect the motion signal from the signal generator 5. In this embodiment, the motion signal includes at least one of an angular displacement and an angular acceleration of the mobile device 100 on at least one coordinate axis of a three-axis coordinate system, and the coordinate system include three aircraft principle axes, namely a yaw axis, a roll axis and a pitch axis. The flow goes to step S542 when the motion signal is detected, and goes back to step S541 when otherwise.

In step S542, the control unit 2 is operable to detect the motion signal on the yaw axis. That is, the control unit 2 detects at least one of an angular displacement and an angular acceleration of the mobile device 100 on the yaw axis. The flow goes to step S543 when the motion signal is detected on the yaw axis, and goes to step S544 when otherwise.

In step S543, the control unit 2 is operable to create a horizontal motion event associated with the at least one of an angular displacement and an angular acceleration of the mobile device 100 on the yaw axis. The flow then goes to step S546.

In step S544, the control unit 2 is operable to detect the motion signal on the pitch axis in a manner similar to step S542. The flow goes to step S545 when the motion signal is detected on the pitch axis, and goes back to step S541 when otherwise.

In step S545, the control unit 2 is operable to create a vertical motion event associated with the at least one of an angular displacement and an angular acceleration of the mobile device 100 on the pitch axis. The flow then goes to step S546. A procedure starting from step S546 is implemented by the control unit 2 for detecting the touch control signal attributed to the first secondary image portion 11. The touch control signal cooperates with the motion signal for providing better interactive effects. For example, when only the motion signal is detected, the first secondary image portion 11 (i.e., the cursor) is moved accordingly on the electronic device 200, while the primary image portion 10 is held still. When the motion signal and a hold control signal associated with the first click button 521 (i.e., as if a left click button of a mouse is clicked and held) are both detected, the primary image portion 10 is instead moved as if being dragged in the direction of the motion signal. The procedure will be described in detail in the following.

In step S546, the control unit 2 is operable to detect the hold control signal associated with the first click button 521 from the signal generator 5. The control unit 2 can be operable to detect the hold control signal, or the touch control signal associated with other buttons in the second secondary image portion 12 in other embodiments. The flow goes to step S547 when the touch control signal is detected, and goes to step S553 when otherwise.

In step S547, the control unit 2 is operable to create a hold event associated with the first click button 521. The hold event is then transmitted, along with either the horizontal motion event or the vertical motion event, to the kernel layer 80 in step S548 and to the framework layer 81 in step S549.

Then, in step S550, the hold event serves as a reference in a callback operation, in which the control unit 2 transmits the hold event from the framework layer 81 to the application layer 82. Thus, the application layer 82 is notified that the first click button 521 is touched.

The flow then goes to step S551, in which the control unit 2 is operable to change appearance of the first click button 521 through the framework layer 81. The first click button 521 thus altered is then displayed by the electronic device 200 for informing the user of a detected touch event on the first click button 521.

In step S552, the control unit 2 is operable to generate a new primary image portion 10 based on either the horizontal motion event or the vertical motion event through the application layer 82. That is, the new primary image portion 10 is shifted accordingly, compared to the original primary image portion 10.

When the hold event is not detected in step S546, the control unit 2 is operable to transmit either the horizontal motion event or the vertical motion event to the kernel layer 80 instep S553 and to the framework layer 81 in step S554.

In step S555, the control unit 2 is operable to generate a new primary image portion 10 based on either the horizontal motion event or the vertical motion event through the application layer 82. That is, the new first secondary image portion 11 (cursor) is moved accordingly, compared to the original first secondary image portion 11.

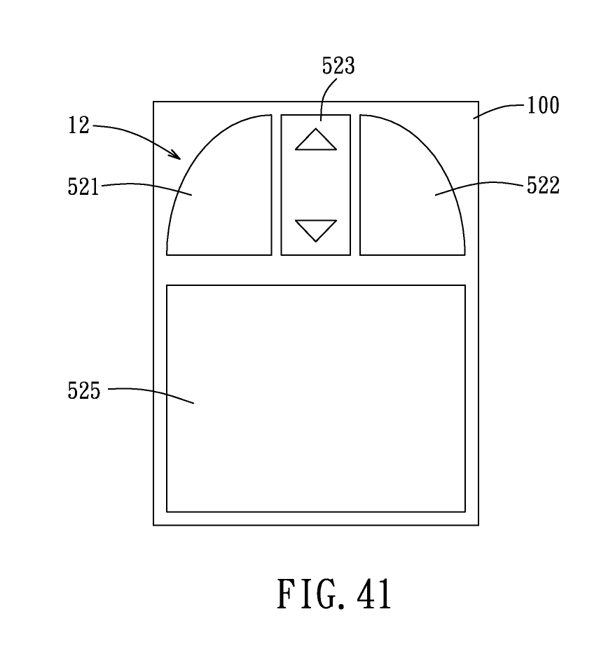

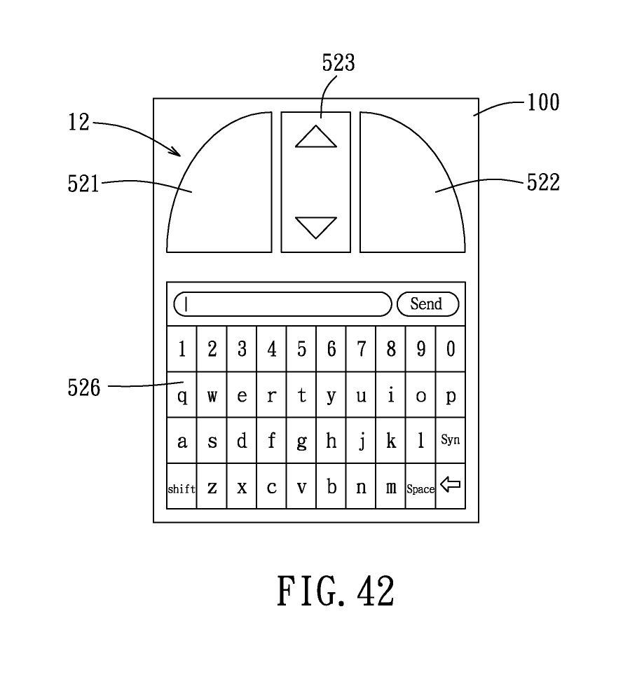

It is noted that, since the display unit 1 of the mobile device 100 is a touch screen, it can be configured such that a part of the display unit 1 serves as a touchpad area 524 which controls the movement of the first secondary image portion 11 (cursor), and that the scroll control button 523 is operable to control the movement of the primary image portion 10. Since the controlling mechanism is similar to that of the first preferred embodiment, further details are omitted herein for the sake of brevity. Alternatively, the second secondary image portion 12 can be configured to include a touch area 525(as shown in FIG. 41) and/or a virtual keyboard area 526 (as shown in FIG. 42) for serving different applications. Furthermore, the signal generator may be operable to generate the control signal solely from the movement of the mobile device 100 for interacting with the electronic device 200, and is not limited to the description of this embodiment.

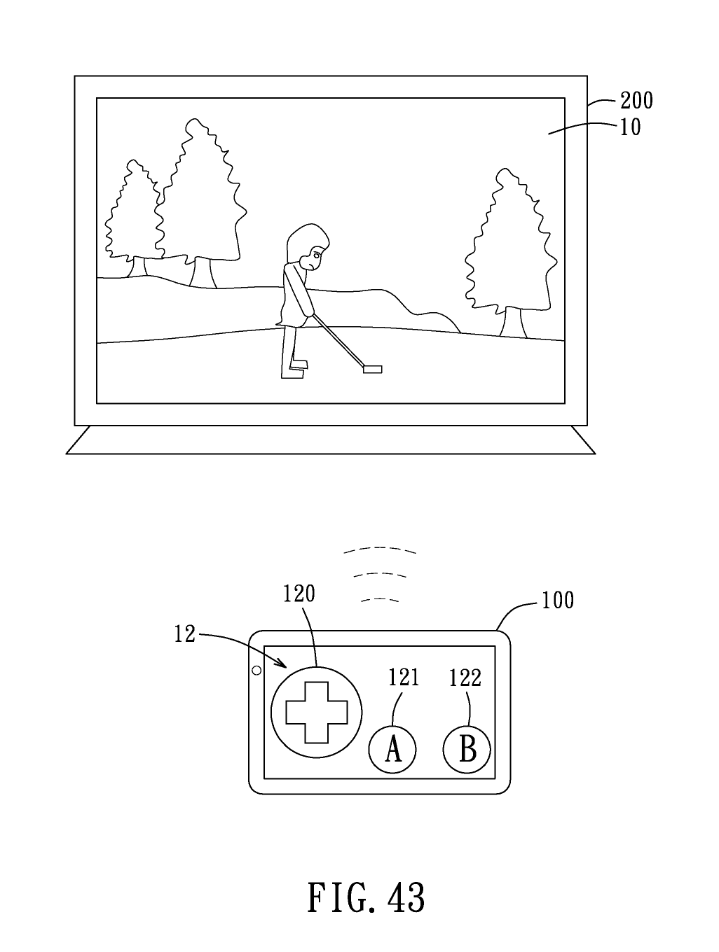

The following paragraphs are directed to the case (e.g., angry bird) of the axis transformation mode, with further reference to FIGS. 5 and 43. This mode is for some specific games that include an axis transformation function for providing a better interactive environment. In this case, the axis transformation is operable to transform the mobile device 100 from the portrait control into the landscape control. That is, the mobile device 100 is configured to perform a coordinate axis transform and the coordinate axis transform involves interchanging two of the axes of the coordinate system.

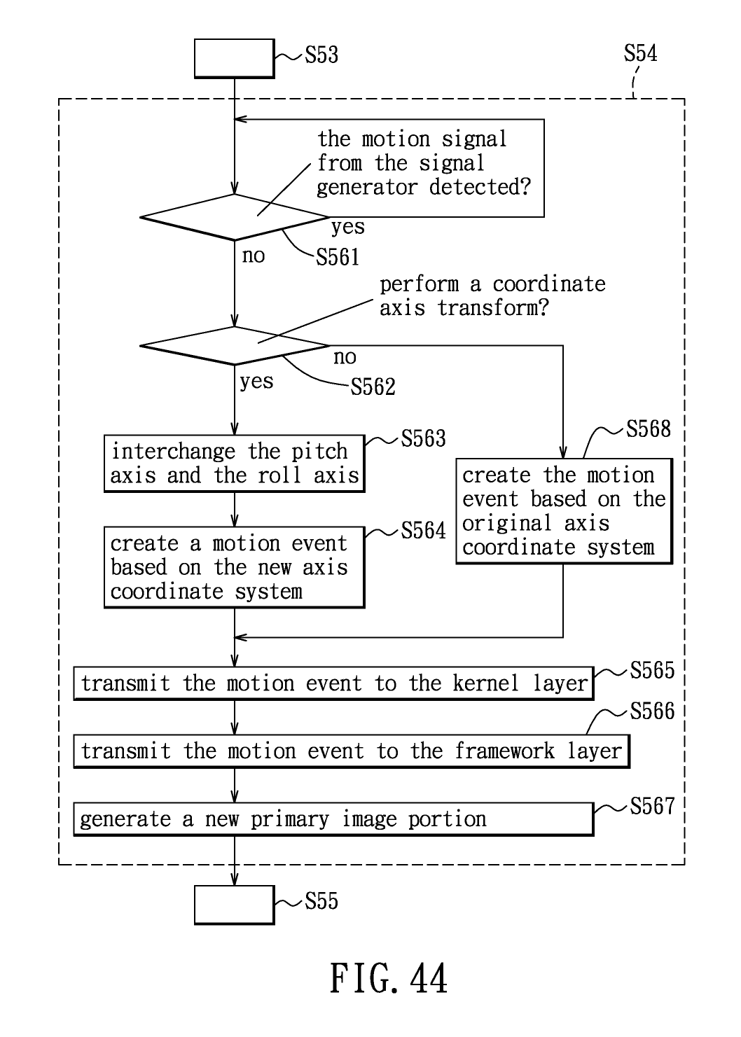

In step S561, referring to FIG. 44, in this procedure, the control unit 2 is operable to detect the motion signal from the signal generator 5 and the flow goes to step S562 when the motion signal is detected, and goes back to step S561 when otherwise.

In step S562, the control unit 2 is operable to determine, based on the application being executed, whether or not the coordinate axis transform is required. The flow goes to step S563 when the coordinate axis transform is required, and goes to step S568 when otherwise.

In step S563, the control unit 2 is operable to interchange the pitch axis and the roll axis that correspond to the movement of the mobile device 100. Accordingly, a new axis coordinate system is obtained. The yaw axis is not changed in this procedure because the signal generator 5 detects the motion signal of the yaw axis in portrait control and landscape control. In other embodiments, the axes can also be changed in other ways (e.g., rotating the coordinate system by 90 degrees about one of the axes), for obtaining other axis coordinate systems.

Then, in step S564, the control unit 2 is operable to create a motion event based on the new axis coordinate system. In addition, in step S568, the control unit 2 is operable to create the motion event based on the original axis coordinate system. The motion event is then transmitted to the kernel layer 80 in step S565 and transmitted to the framework layer 81 in step S566.

In step S567, the control unit 2 is operable to generate a new primary image portion 10 based on the motion event.

It has been shown that the aforementioned procedures in combination with the multilayer architecture are capable of processing the interaction between the mobile device 100 and the electronic device 200 in all cases involving both the air mouse mode and the axis transformation mode. The fifth preferred embodiment has the same advantages as those of the previous preferred embodiments.

To sum up, since the mobile device 100 of this invention is operable to transmit the primary image portion 10 to the electronic device 200 for display by the electronic device 200, and is operable to transform the first secondary image portion 11 into the second secondary image portion 12 that conforms with a specified presentation, the interaction between the mobile device 100 and the electronic device 200 is achieved, thereby providing the user with a relatively more friendly environment.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for interacting a mobile device with an electronic device having a display function, the mobile device being operable to display at least one image, the image being generated by a processor of the mobile device that executes a program, the image including a primary image portion and a first secondary image portion that is superimposed on the primary image portion, said method comprising the following steps of:
a) configuring the mobile device to transmit the primary image portion to the electronic device for display by the electronic device;
b) configuring the mobile device that executes the program to transform the first secondary image portion into a second secondary image portion that conforms with a specified presentation;
c) configuring the mobile device to display the second secondary image portion;
d) configuring the mobile device that executes the program to generate a new primary image portion in response to a control signal generated as a result of user operation; and
e) configuring the mobile device to transmit the new primary image portion to the electronic device for display by the electronic device.

2. The method as claimed in claim 1, wherein:
the second secondary image portion serves as a user interface and includes a button image; and
in step d), the control signal is generated as a result of user interaction with the button image of the second secondary image portion.

3. The method as claimed in claim 2, further comprising a step of configuring the mobile device to change appearance of the button image.

4. The method as claimed in claim 2, wherein:
in step c), the second secondary image portion is displayed on a touch screen of the mobile device; and
in step d), the control signal is generated as a result of a touch event on the button image of the second secondary image portion that is displayed on the touch screen of the mobile device.

5. The method as claimed in claim 4, wherein, in step a), the mobile device is further configured to transmit the first secondary image portion for display by the electronic device.

6. The method as claimed in claim 5, wherein, in step d), the mobile device is further configured to indicate, in the first secondary image portion transmitted to the electronic device, the touch event on the button image of the second secondary image portion for interaction with a user.

7. The method as claimed in claim 2, wherein, in step d), the control signal includes
a touch control signal generated as a result of a touch event on the button image of the second secondary image portion that is displayed on a touch screen of the mobile device, and
a motion signal generated by a motion detector of the mobile device in response to movement of the mobile device by a user.

8. The method as claimed in claim 1, wherein, in step d), the control signal is a motion signal that is generated by a motion detector of the mobile device in response to movement of the mobile device by a user.

9. The method as claimed in claim 8, wherein the motion signal includes at least one of an angular displacement and an angular acceleration of the mobile device along at least one coordinate axis of a coordinate system.

10. The method as claimed in claim 9, wherein in step d), the mobile device is further configured to perform a coordinate axis transform according to the motion signal and an orientation of the second secondary image portion displayed by the mobile device.

11. The method as claimed in claim 10, wherein the coordinate system is a three-axis coordinate system, and the coordinate axis transform involves interchanging two of the axes of the coordinate system.

12. The method as claimed in claim 1, wherein, in step d), the control signal is a press signal generated by a peripheral device operatively coupled to the mobile device, and the new primary image portion is generated directly in response to the press signal.

13. The method as claimed in claim 1, wherein, in step b), the specified presentation is determined by a user via a user interface of the mobile device.

14. A method for interacting a mobile device with an electronic device having a display function, the mobile device being operable to display at least one image, the image being generated by a processor of the mobile device that executes a program, said method comprising the following steps of:
a) configuring the mobile device to transmit the image to the electronic device for display by the electronic device;
b) configuring the mobile device to generate a new image in response to a control signal from a peripheral device that is operatively coupled to the mobile device; and
c) configuring the mobile device to transmit the new image to the electronic device for display by the electronic device.

15. The method as claimed in claim 14, wherein, in step b), the control signal is a press signal generated upon pressing a press key unit of the peripheral device.

16. The method as claimed in claim 15, the image including a primary image portion and a secondary image portion that is superimposed on the primary image portion, wherein, in step c), new ones of the primary image portion and the secondary image portion are transmitted to the electronic device, and the secondary image portion presents an indication of the press key unit being pressed.

17. The method as claimed in claim 14, wherein the peripheral device includes a joystick or gamepad communicating wirelessly with the mobile device, wherein, in step b), the new image is generated according to operation of the joystick or gamepad.

18. A mobile device that is operable to implement the method as claimed in claim 1.

19. A mobile device that is operable to implement the method as claimed in claim 14.

20. An interactive system comprising:
an electronic device having a display function; and
a mobile device that is operable to implement the method as claimed in claim 1, such that the mobile device is capable of interacting with the electronic device in real time.

21. An interactive system comprising:
an electronic device having a display function; and
a mobile device that is operable to implement the method as claimed in claim 14, such that the mobile device is capable of interacting with the electronic device in real time.
